(19) United States
(12) Patent Application Publication
(10) Pub. No.: US 2023/0192946 A1
(43) Pub. Date: Jun. 22, 2023

(54) POLYESTERS PREPARED FROM 1,1-DIESTER-1-ALKENES CONTAINING A STRONG ACID AND STABILIZER

(71) Applicant: Nippon Shokubai Co., Ltd., Osaka-Shi (JP)

(72) Inventors: Mathew Sanyo, Blue Ash, OH (US); Alexander Y. Polykarpov, Brunswick, OH (US); Aniruddha Palsule, Cincinnati, OH (US); Jeffrey M. Sullivan, Cincinnati, OH (US); Kazuyuki Oshima, Osaka (JP); Camille Boucher-Jacobs, Loveland, OH (US); Alexander R. Holzer, Morrow, OH (US); Jeff Uhrig, Media, PA (US); Toshiya Iida, Osaka (JP); Hayato Miwa, Osaka (JP); Hikaru Takahashi, Osaka (JP); J. Taylor Goodrich, Loveland, OH (US); Anushree Deshpande, Cincinnati, OH (US)

(21) Appl. No.: 17/924,188

(22) PCT Filed: Jun. 9, 2021
(86) PCT No.: PCT/US2021/036561

§ 371 Date: Nov. 9, 2022

Related U.S. Application Data
(60) Provisional application No. 63/037,793, filed on Jun. 11, 2020.

(51) Int. Cl. C08G 63/52; C08G 63/676; C08G 63/78; C08K 3/30; C08K 3/32; C08K 5/42

(52) U.S. Cl. CPC C08G 63/52; C08G 63/676; C08G 63/785; C08K 3/30; C08K 3/32; C08K 5/42; C08K 2003/309; C08K 2003/329

(57) ABSTRACT

Disclosed are compositions comprising polyesters containing a chain of residue of: diols and diesters along the chain, wherein at least a portion of the diesters are 1, 1-diester-1-alkenes, and the chains have alkene groups incorporated into the chains; the composition comprising one or more of the following: i ether groups derived from alcohols, diols, polyols, or a combination thereof obtained via Michael addition to the alkene groups and a residue of the alkene groups remaining after Michael addition; ii the formed polyesters contain one percent or less of residual 1, 1-diester-1-alkene which are unreacted; iii one or more free radical inhibitors; and iv a stabilizer comprising one or more of: oxo acids phosphorous or esters thereof, aluminum sulfate, stannous pyrophosphate, stannous sulfate, aluminum dihydrogenphosphate or decomposition products thereof. The stabilizer is present in an amount sufficient to enhance stability of the polyester without lowering reactivity of the polyester.

### FIELD

Disclosed are compositions containing polyesters prepared from 1,1-diester-1-alkenes containing strong acids and stabilizers. Disclosed are compositions useful in preparing the polymer compositions and methods for preparing such compositions.

### BACKGROUND

Polyesters are utilized in several applications due to their properties and ease of synthesis. Exemplary uses include coatings, films, fibers, and various resins. Polyesters are also utilized in blends with other polymers to improve certain property limitations of the other polymers, including polycarbonates, polyamides, polystyrene and styrene copolymers, polyolefins, and the like. Polyesters can be prepared by transesterification, such as by reacting diesters with polyols, and while many are linear in structure some have branched structures.

1,1-diester-1-alkenes, such as methylene malonates, contain two ester groups, and an alkylene group disposed between the two ester groups. Recent developments in synthesis of these compounds facilitate the synthesis of these compounds and their use in a variety of applications, see Malofsky U.S. Pat. Nos. 8,609,885; 8,884,051; and 9,108,914; incorporated herein by reference in their entireties for all purposes. Processes for transesterifying these compounds have been developed. Malofsky et al. WO 2013/059473, US 2014/0329980, incorporated herein by reference in their entirety for all purposes, discloses the preparation of multifunctional methylene malonates by multiple synthetic schemes. One disclosed process involves reacting at least two methylene malonates with a polyol in the presence of a catalyst to prepare compounds wherein one of the ester groups on the methylene malonates undergoes transesterification to react with the polyol and form multifunctional compounds (multifunctional meaning the presence of more than one methylene malonate core unit). The use of enzyme catalysis is disclosed. Sullivan, U.S. Pat. No. 9,416,091 discloses transesterification of 1,1-disubstituted-1-alkenes using certain acid catalysts, incorporated herein by reference in its entirety for all purposes. The compositions disclosed include multifunctional 1,1-diester-1-alkenes where substantially all of the hydroxyl groups of polyols are incorporated into the polyester backbone with the 1, 1-diester-1-alkenes. Palsule U.S. Pat. No. 9,617,377 discloses polyesters prepared from 1,1-diester-1-alkenes, polyols, and other diesters using both enzymatic and strong acid catalysts, incorporated herein by reference in its entirety for all purposes. The polyesters disclosed demonstrate advantageous properties. Transesterification using strong acid catalysis is usually the most economical option for large scale synthesis of the polyesters. The concern with the strong acid catalyzed process is that the residual catalyst can inhibit further reactivity of the polyesters and it is desirable to limit the amount of residual strong acid in the product. A balance of storage stability of the polyesters with on demand reactivity is demanded by customers. The polyesters can be polymerized by anionic and free radical mechanisms. To be shelf stable the polyesters need to be stabilized against polymerization by both mechanisms until polymerization is desired. Known anionic stabilizers are strong acids, such as sulfonic acids or halogenated carboxylic acids. During transesterification these acids can also be converted to esters, which can greatly reduce the anionic stabilization of the polyester and lead to gelation of either the reaction mixture or reaction product. Thus, an even greater excess of these acids is needed to assure sufficient stabilization of the polyester during the synthesis and in storage, which in turn further reduces the reactivity of the polyester product and makes the balance of stabilization and on demand reactivity difficult to attain. The presence of high levels of residual unreacted 1,1-diester-1-alkenes can negatively impact the polyesters functionality and use. It is desired to reduce the presence of residual unreacted 1,1-diester-1-alkenes in the polyesters.

What is needed are polyester compositions containing the residue of 1,1-diester-1-alkenes in the backbone that: are reactive at room temperature upon demand, shelf stable, contain a low amount of residual 1,1-diester-1-alkenes, and have controlled amounts of by-products and residual strong acid compounds. What are needed are compositions containing the 1,1-diester-1-alkenes or the residue of 1,1-diester-1-alkenes which are shelf stable and which can polymerize when exposed to anionic polymerization catalysts. What are needed are processes for the preparation of polyesters containing the residue of 1,1-diester-1-alkenes in the backbone of the polyester which are scalable from lab or pilot plant processes to semi-commercial and commercial scale.

### SUMMARY

Disclosed are compositions comprising polyesters containing one or more chains of the residue of: diols and diesters along the chain, wherein at least a portion of the diesters are 1, 1-diester-1-alkenes, and the chains have alkene groups incorporated into the chains; wherein the composition comprises one or more of the following: ether groups derived from hydroxyl containing compounds, for instance alcohols, diols, polyols, or a combination thereof, obtained via Michael addition to the alkene groups and a portion of the alkene groups remaining after Michael addition; the formed polyesters contain one percent or less by weight of the 1, 1-diester-1-alkenes which are unreacted; one or more free radical inhibitors; and a stabilizer comprising one or more of: oxo acids of phosphorus or esters thereof, aluminum sulfate, stannous pyrophosphate, stannous sulfate, aluminum dihydrogenphosphate, phosphate esters, or decomposition products thereof. The stabilizer is present in an amount sufficient to enhance stability of the polyester without lowering the reactivity of the polyester. The stabilizer may be one or more of pyrophosphoric acid, hypophosphoric acid, tripolyphosphoric acid, tetrapolyphosphoric acid, trimetaphosphoric acid, phosphoric anhydride, phosphoric acid, polyphosphoric acid, aluminum sulfate, stannous pyrophosphate, stannous sulfate, aluminum dihydrogenphosphate, phosphate esters, or decomposition products thereof. The composition may contain phosphoric acid, pyrophosphoric acid, phosphate esters or decomposition products thereof. The stabilizer may be present in the composition in an amount of from about 1 part per million to about 100 parts per million based on the weight of the composition. The one or more 1,1-diester-1-alkenes may be one or more 1,1-di-C₁₋₆ alkylester or di-C₅₋₆ cycloalkylester-1-alkenes. The composition includes one or more strong acids. The one or more strong acids may be present in an amount of about 300 parts per million or less or 100 parts per million or less. The one or more strong acids may be present in a concentration of about 20 parts per million or less. The one or more stabilizers may be present in an amount of about 1 part per million or more based on the weight of the composition. The composition may include two or more free radical inhibitors. The two or more free radical inhibitors may be one or more alkylated hydroxyanisoles and one or more alkylated hydroxytoluenes. The composition may include an amount of free radical stabilizer sufficient to prevent radical polymerization. The alkylated hydroxyanisoles and alkylated hydroxytoluenes may be present in a ratio of about 1:2 to about 2:1. The composition includes an amount of free radical stabilizer sufficient to prevent radical polymerization. The composition may include Michael adducts of the polyester that formed during its preparation. The percentage of the alkene groups present in the polyester that were not converted to Michael adducts may be about 55 or more, about 65 or more, about 70 or more or about 75 or more. The amount of unreacted 1, 1-diester-1-alkenes present in the polyester may be about 0.1 percent by weight or less or about 0.05 percent or less.

Disclosed are compositions useful in preparing polyesters as disclosed herein. The compositions are polymerizable compositions comprising: one or more diols; one or more diesters wherein such diesters comprise one or more 1, 1-diester-1-alkenes; and one or more stabilizers comprising disclosed herein; wherein the composition forms one or more polyesters containing one or more chains of the residue of diols and diesters, and the chains have alkene groups incorporated into the chains. The 1, 1-diester-1-alkenes may be one or more 1,1-di-C₁₋₆ alkylester-1-alkenes and 1,1-di-C₅₋₆ cycloakylester-1-alkenes. The stabilizer is added in an amount sufficient to enhance stability of the polyester formed from the composition without lowering reactivity of the polyester. The stabilizer may be one or more of: pyrophosphoric acid, hypophosphoric acid, tripolyphosphoric acid, tetrapolyphosphoric acid, trimetaphosphoric acid, phosphoric anhydride, phosphoric acid, polyphosphoric acid, aluminum sulfate, stannous pyrophosphate, stannous sulfate, aluminum dihydrogenphosphate, phosphate esters, or decomposition products thereof. The stabilizer may be phosphoric acid, pyrophosphoric acid or one or more phosphate esters. The stabilizer may be present in an amount of about 1 part per million to about 100 parts per million by weight of the composition. The composition may contain one or more strong acids. The strong acids may be present in a concentration of about 300 parts per million to about 1 part per billion based on the weight of the composition. The one or more strong acids may be present in a concentration of about 100 parts per million or less and the one or more stabilizers may be present in an amount of about 1 part per million or more based on the weight of the composition. The composition may include one or more free radical inhibitors or two or more free radical inhibitors. The two or more free radical inhibitors may comprise one or more alkylated hydroxyanisoles and one or more alkylated hydroxytoluenes. The alkylated hydroxyanisoles and alkylated hydroxytoluenes may be present in a ratio of about 1:2 to about 2:1. The composition includes an amount of free radical stabilizer sufficient to prevents radical polymerization.

Disclosed is a method comprising a) contacting one or more polyols with one or more diesters wherein a portion of the diesters are 1,1-diester 1-alkenes in the presence of a stabilizer comprising one or more of: oxo acids of phosphorous or esters thereof, aluminum sulfate, stannous pyrophosphate, stannous sulfate, aluminum dihydrogenphosphate, phosphate esters, or decomposition products thereof; b) exposing the contacted compounds to conditions under which a composition comprising one or more polyesters as disclosed herein are formed. The one or more polyols and one or more 1,1-diester-1-alkenes may be contacted in the presence of a strong acid. During the method disclosed the acids and/or stabilizers may be converted into esters. The method may comprise adding one or more free radical inhibitors to the reaction product, the free radical inhibitors and the amounts thereof are disclosed in paragraphs provided hereinbefore. The method may comprise removing, after step a, volatile by-products, unreacted 1,1-diester 1-alkenes, or both. This may be achieved by elevating the temperature of the reaction mixture or product. The method may comprise applying a vacuum while the temperature of the product is elevated. The disclosed method may comprise a separate step for removing by-products prepared during the formation of the polyesters such as alcohols, such as C₁₋₆ alkanols or C₅₋₆ cycloalkanols. The by-products may be removed by volatilizing them off during the polyester formation step or by a separate distillation step. The disclosed method may comprise removing the unreacted 1,1-diester-1-alkenes remaining after formation of the polyesters. After removing the unreacted 1,1-diester-1-alkenes remaining after step a, the unreacted 1,1-diester-1-alkenes in the polyester formed may be present in an amount of about 1.0 percent or less based on the weight of the composition formed or about 0.1 percent or less. The unreacted 1,1-diester 1-alkenes may be removed by distillation, vacuum, contact with a solvent that entrains such compounds, exposure to elevated temperatures, contact with a nitrogen stream or any combination thereof. The unreacted 1,1-diester 1-alkenes may be removed by distillation using a wiped film evaporator. Free radical stabilizers, such as 2,2′-methylene-bis-6-tert-butyl-4-methylphenol, may be added to the polyester formed while the composition is subjected to distillation to remove the residual the unreacted 1,1-diester-1-alkenes during distillation, such as passing the polyester containing product stream through a wiped film evaporator. The method may comprise applying vacuum to the polyester formed during distillation, such as by passing it through a wiped film evaporator. The amounts of stabilizers, strong acids added are described hereinbefore.

Disclosed are polyester compositions that are reactive at room temperature and/or ambient temperature, shelf stable, contain low amounts of residual 1,1-diester-1-alkenes used to prepare the polyesters, have controlled amounts of by-products, or a combination thereof. Disclosed are compositions that are stable against free radical polymerization and anionic polymerization. The disclosed are polyesters which are storage stable and which polymerize efficiently on demand under mild conditions.

### DESCRIPTION OF FIGURE

FIG. 1 illustrates the pot life obtained for the polyester made by this catalysis for 3 different concentrations of ethyl methyl piperidine carboxylate.

### DETAILED DESCRIPTION

The explanations and illustrations presented herein are intended to acquaint others skilled in the art with the disclosure, its principles, and its practical application. The specific embodiments of the present disclosure as set forth are not intended to be exhaustive or limiting thereof. The scope of the disclosure should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description. Unless defined otherwise, all technical and scientific terms used herein have the meaning commonly understood by a person skilled in the art.

The term “stabilized” (e.g., in the context of “stabilized” 1,1-diester-1-alkenes, or compositions comprising the same), refers to the tendency of the compounds (or their compositions) to substantially not polymerize with time, to substantially not harden, form a gel, thicken, or otherwise increase in viscosity with time, and/or to substantially show minimal loss in reactivity or cure speed (i.e., cure speed is maintained) with time. Residue with respect to an ingredient or reactant used to prepare the polyesters disclosed herein means that portion of the ingredient, such as a polyol, a diol, a diester, a 1,1-diester-1-alkene and/or a dihydrocarbyl dicarboxylate, that remains in the compound after inclusion as a result of the methods disclosed herein. Substantially all as used herein means that greater than 90 percent of the referenced parameter, composition or compound meet the defined criteria, greater than 95 percent, greater than 99 percent of the referenced parameter, composition or compound meet the defined criteria, or greater than 99.5 percent of the referenced parameter, composition or compound meet the defined criteria. One or more as used herein means that at least one, or more than one, of the recited components may be used as disclosed. Heteroatom refers to atoms that are not carbon or hydrogen such as nitrogen, oxygen, sulfur, and phosphorus; heteroatoms may include nitrogen and oxygen. Hydrocarbyl, as used herein, refers to a group containing one or more carbon atom chains and hydrogen atoms, which may optionally contain one or more heteroatoms. Where the hydrocarbyl group contains heteroatoms, the heteroatoms may form one or more functional groups well-known to one skilled in the art. Hydrocarbyl groups may contain cycloaliphatic, aliphatic, aromatic, or any combination of such segments. The aliphatic segments can be straight or branched. The aliphatic and cycloaliphatic segments may include one or more double and/or triple bonds. Included in hydrocarbyl groups are alkyl, alkenyl, alkynyl, aryl, cycloalkyl, cycloalkenyl, alkaryl, and aralkyl groups. Cycloaliphatic groups may contain both cyclic portions and noncyclic portions. Hydrocarbylene means a hydrocarbyl group or any of the described subsets having more than one valence, such as alkylene, alkenylene, alkynylene, arylene, cycloalkylene, cycloalkenylene, alkarylene and aralkylene. Alkyl as used herein refers to straight and branched chain alkyl groups. Percent by weight or parts by weight refer to, or are based on, the weight or the compounds or compositions described unless otherwise specified. Unless otherwise stated parts by weight are based 100 parts of the composition.

Disclosed are polyester compositions prepared from polyols, such as diols, and one or more diesters, wherein at least a portion of the diesters are 1,1-diester-1-alkenes. The structures of the formed polyesters are disclosed hereinafter. The formed polyesters contain in their backbones carbon atoms disposed between two carbonyl groups wherein these carbon atoms are doubly bonded to a second carbon atom wherein the second carbon atom is not included in the backbone of the polymer, hereinafter 1-alkene groups. A portion of the 1-alkene groups may be reacted with a Michael Donor, such that the Michael Donor adds to the 1-alkene groups. The polyesters may have unreacted 1-alkene groups and 1-alkene groups which are reacted with Michael Donors.

Disclosed are compositions comprising polyesters containing, in one or more polymer chains, the residue of one or more diols and one or more diesters, wherein the residue of the one or more diols and the one or more diesters alternate along the chain and a portion of the diesters are 1,1-diester-1-alkenes. The polyesters contain 1-alkene groups wherein a portion of the 1-alkene groups may be reacted with one or more Michael Donors. A portion of the diesters may be 1,1-hydrocarbylene dihydrocarbylcarboxylates. The polyester may have two or greater of such chains. The chains may include the residue or one or more hydrocarbylene dihydrocarbylcarboxylates. The chains may contain the residue of one or more diols and one or more diesters wherein the diesters comprise one or more 1,1-diester-1-alkenes. The residue of the one or more diols and the one or more 1,1-diester-1 alkenes and optionally one or more hydrocarbylene dihydrocarbylcarboxylates may be randomly disposed along the chains. The backbone of polyesters contains a sufficient number of repeating units comprising the residue of at least one diester and one diol to facilitate the use of the polyesters as disclosed herein. The number of repeating units comprising the residue of at least one diester and one diol in the polyesters may be 2 or greater, 4 or greater or 6 or greater. The number of repeating units comprising the residue of at least one diester and one diol in the polyesters may be 20 or less, 14 or less, 10 or less, 8 or less, 6 or less, or 4 or less. The diesters in some polyesters may be all 1,1-diester-1-alkenes. The diesters in some polyesters can be 1,1-diester-1-alkenes and hydrocarbylene dihydrocarbylcarboxylates. The molar ratio of 1,1-diester-1-alkenes and hydrocarbylene dihydrocarbylcarboxylates in some polyesters may be selected to provide the desired number of alkene groups incorporated into the chains which are sites available for addition of Michael Donors or crosslinking. The molar ratio of 1,1-diester-1-alkenes and hydrocarbylene dihydrocarbylcarboxylates in some polyesters may be 1:1 or greater, 6:1 or greater or 10:1 or greater. The molar ratio of 1,1-diester substituted-1-alkenes and hydrocarbylene dihydrocarbylcarboxylates in some polyesters may be 200:1 or less, 100:1 or less, 15:1 or less, 10:1 or less 6:1 or less or 4:1 or less. The polyesters may exhibit a number average molecular weight of about 700 or greater, about 900 or greater, about 1000 or greater or about 1200 or greater. The polyesters may exhibit a number average molecular weight of about 10,000 or less. Number average molecular weight as used herein may determined dividing total weight of all the polymer molecules in a sample, by the total number of polymer molecules in a sample or determined using gel permeation chromatography (GPC) using polymethylmethacrylate standards. The polydispersity of the polyesters may be about 1.05 or greater or about 1.5 or greater. The polydispersity of the polyesters may be about 4.5 or less, about 2.5 or less, or about 1.5 or less. For calculating the polydispersity, the weight average molecular weight is determined using gel permeation chromatography (GPC) using polymethylmethacrylate standards. Polydispersity is calculated by dividing the measured weight average molecular weight (Mw) by the number average molecular weight (Mn), that is Mw/Mn. For GPC measurement, 2 of PLgel MIXED-C (7.5×300 mm, 5 μm, 200-2,000,000 Mw) columns in series and PLgel MIXED-C (7.5×50 mm, 5 μm, 200-2,000,000 Mw) as guard column were used. 0.01 wt % of MSA in THF was used as an eluent at a feed rate of 1 ml/min. Total runtime is 30 minutes. Peaks between retention times of 15 minutes and 19.5 minutes are integrated to determine Mw and Mn excluding high molecular weight species (higher than 10,000 as Mw of polymethylmethacrylate (standard)) and low molecular weight species including residual 1,1-diester-1-alkenes such as diethyl methylene malonate (DEMM) which are unreacted.

The polyester may be a straight chain polymer wherein only two of the disclosed chains propagate from an initiating polyol. The polyester may have three or more chains as described. The polyester having three or more chains may contain the residue of an initiating polyol originally having three or greater hydroxyl groups. The three or more chains may propagate from each of the three or more hydroxyl groups. The polyols having three or more hydroxyl groups may function as initiators from which each of the chains of the polyester propagate. The polyester may be a linear chain polymer, a branched polymer, a star polymer, a cross-linked polymer, or a combination thereof. A polyester may be formed with complex architecture polymer chains (e.g., star, comb, brush, dendronized, dendrimers, ring, palm tree, dumbbell, coil-cycle-coil). A branched polymer chain may be obtained when polyols having three or more hydroxyl groups are used as initiators or are present in the reaction mixture. If the initiating polyols are diols the polyester formed may be linear. A polymer with branching, crosslinking, or both may result due to Michael addition of hydroxyl functional groups to methylidene malonate groups. Where a polyol having three or more hydroxyls is used to prepare the polyester, the polyester may have two or more chains as not all of the hydroxyls may propagate chains. The polyesters may contain one or more chains, two or more chains or may contain three or more chains. The polyesters may contain eight or less chains, six or less chains, four or less chains or three or less chains. The polyester chains may have one or more alkene groups incorporated into the chains. The polyesters formed may contain a residual amount of starting 1,1-diester-1-alkenes of about 1 percent or less, about 0.5 percent or less, about 0.1 percent or less, or about 0.05 percent or less by weight of the total weight of the reaction product, the polyester, the composition, or a combination thereof.

The polyester may correspond to Chemical Structure 1:

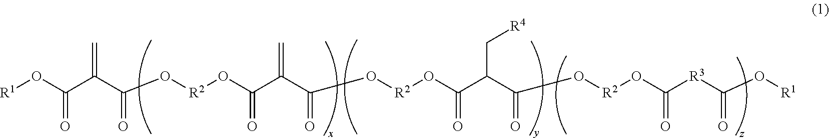

wherein R² is a diol or polyol residue, R¹ may be separately in each occurrence hydrocarbyl group or, R²(OH)_{c-1} (a polyol residue), R⁴ may be separately in each occurrence an oxygen further bonded to one of a hydrocarbyl, polyol residue, or another polyester chain linked via polyol residue, R³ may be separately in each occurrence a hydrocarbylene, that does not have 1-alkene groups but may have other unsaturated groups. The ratio of X to Y is the ratio of number of alkene groups to the number of Michael adduct groups, where Z can be calculated from the remaining molecular weight of the polyester. The units in the parenthesis designated x contain units having the 1-alkene groups in the chain. The units in the parenthesis designated y contain units having the 1-alkene groups in the chains reacted with a Michael donor. The units in the parenthesis designated z contain units having the residue of the hydrocarbylene dicarboxylates. In chemical structure 1 the units within the parenthesis preceding each of x, y and z may be in a random order, that is along a chain the units of each group may be in any order. X, Y, Z can be determined through GPC and NMR analysis of the formed polyesters. The choice of specific ingredients, ratios of ingredients and sequence of process steps impact the final structure and content of the polyesters. The polyesters disclosed may be prepared as disclosed in U.S. Pat. No. 9,617,377 incorporated herein by reference in its entirety, wherein the process is modified as specifically described herein.

The polyesters may have a portion of the 1-alkene groups present in the backbone reacted with Michael donors. Multifunctional Michael donors may form crosslinks between polyester chains or induce branching in the polylesters. The Michael donors may comprise one or more compounds, oligomers or polymers which have functional groups which are capable of Michael adding to alkene groups. The functional groups include functional groups containing active hydrogen groups that react with an electrophilic unsaturated group such as the 1-alkene groups from the 1,1-diester alkene compounds. The functional groups, Michael Addition donor groups, may comprise, hydroxyls. Any compounds with the Michael Addition donor groups may be utilized. The Michael Donors can be added to the reaction mixture utilized to prepare the polyesters for the purpose of forming Michael Adducts. The Michael Donors can be reactants used to prepare the polyesters, intermediates formed in the preparation of the polyesters or by-products formed during the preparation of the polyesters. The Michael adducts can be formed during the preparation of the polyesters, after preparation of the polyesters or at any time after the recovery of the polyesters. The polyols or diols added to the reaction mixture to form the polyesters may Michael add to the 1-alkene groups. Intermediates that are formed during the preparation of the polyesters which have active hydrogen atoms may Michael add to the 1-alkene groups. Examples of the intermediates include reaction product of one or more polyols, including diols, with one or more 1,1-diester-alkenes which have terminal hydroxyl groups, including oligomers formed from multiple 1,1-diester-alkenes and polyols, adducts of one 1,1-diester-alkene with two polyols or one 1,1-diester-alkene with one polyol. The Michael Donor may be a polyester with a terminal hydroxyl group. The Michael Donor may be a polyester having a polyol Michael added to a 1-alkene group wherein one or more Michael donors are still present on the polyol, in this case the polyol may form a branched structure or form one of two or more crosslinks between the polyesters. Disclosed are branched polyesters wherein the branching is a result of Michael addition of polyols. The polyols may be short chain or long chain polyols. The Michael Donors may be compounds containing one or more hydroxyl groups. The polyesters are prepared by transesterification of the 1,1-diester-1-alkenes with polyols. The ester groups are removed in the process and form alcohols, in many situations monols, compounds with a single hydroxyl group. The formed alcohols are labile and can come into contact with the 1-alkene groups and Michael add thereto. The one or more Michael Donor compounds may be present in the polyester is a sufficient amount to provide the desired number of Michael Donor groups added 1-alkenes.

The Michael addition results in the formation of ether in the place of the 1-alkene groups, which can be referred to as Oxa Michael Addition. The ether groups may be connected to the polyester through the residue of the 1-alkene groups. The Michael adducts replace a portion of the 1-alkene groups. The Michael adducts may be present in a reaction product and then removed before a final composition is formed. Some Michael adducts, may be removed and some may remain in a final composition. Each Michael Adduct may replace one alkene group on a polyester chain. The Michael Adducts may be straight chain or branched chain compounds or polymers. The Michael Adducts may be branched chain compounds or polymers.

Michael addition may be controlled via the processes disclosed herein. The number of Michael Adducts may be increased by allowing the reaction to run longer or may be decreased by stopping a reaction, such as by adding a quenching agent. The amount of Michael adducts may be controlled via retro-Michael addition. For example, retro-Michael addition may be performed to remove some Michael adducts, to change the number of unsaturated bonds (e.g., percent unsaturated), or both. Retro-Michael addition may be performed by heating the composition and/or contacting the polyesters with catalysts which catalyze the breakup of Michael added groups. Exemplary catalysts for breaking up Michael added groups include acids as described herein. The Michael Adducts may replace an alkene group and reduce the number of double bonds present in the polyester, chain, or both. Examples of Michael adducts formed during the production reaction of 1, 4-Butanediol with diethyl methylene malonate are shown by Chemical Structures 2, 3, or 4:

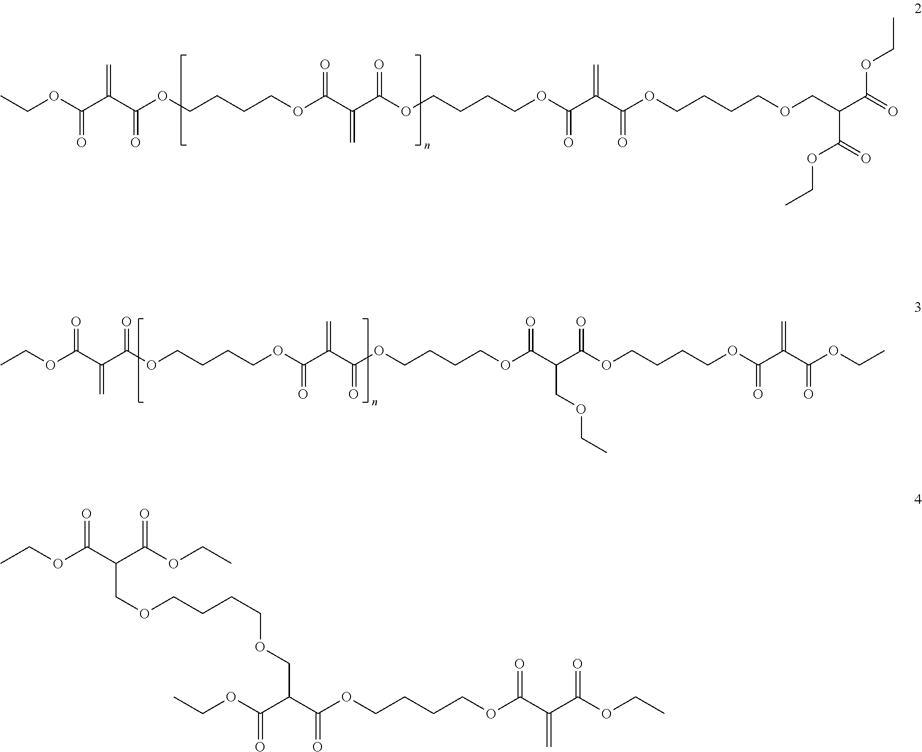

The number of Michael additions in the chain of the polyester may be inversely proportional to the percent of unsaturated of alkene groups in the polyester chain after Michael addition.

The number of Michael additions may be measured by NMR. The percent unsaturated bonds and the percent saturated bonds may be inversely proportional. The percent unsaturation or percent saturation functions to provide a determination of a number of double bonds remaining after Michael addition, retro-Michael addition, Oxa-Michael addition, or a combination thereof. The percent unsaturation may be determined by measuring the number of all double bonds present in the chain before and after the chain is subjected to transesterification, Michael addition, Oxa-Michael addition, retro-Michael addition, or a combination thereof and comparing the percentages before and after. In one example, a 1,4-butadediol with diethyl methylene malonate has a number of double bonds or a percentage of double bonds measured and then is subjected to an acid (e.g., sulfuric acid or sulfonic acid) to trigger a catalyzed transesterification of the methylene malonates with polyols and some of the alkenes are converted into Michael adducts. The percent unsaturation may be determined after substantially all of the residual 1,1-diester-1-alkenes (e.g., diethyl methylene malonate (DEMM)) are removed. The amount of remaining double bonds (or a percentage of the carbon-carbon double bonds remaining (e.g., exclusive of the carbinols or other double bonds)) are divided by the amount of original double bonds to provide the percent unsaturation. For example, if there were a relative percentage of 75% double bonds before transesterification and relative percentage of 70% after transesterification then the percent unsaturation can be calculated as (70/75)*100=93% relative percentage. In another example, if the double bond content before transesterification or Michael addition was 16 percent and then after transesterification or Michael addition the double bond content was 13.5 percent then 13.5/16 results in a relative percent of unsaturation of 84.3. The relative percent of unsaturation (e.g., unsaturated bonds) may impact stability, shelf life, or both. A composition with higher relative percent of unsaturation may be more stable, have a longer shelf life, or both. Depending upon a desired stability the percent unsaturation may be manipulated. Shelf life may be controlled by inhibiting the Michael addition or enhancing retro-Michael addition so that more alkene groups remain. The process as discussed herein may affect the relative percent of unsaturation by the amount of acid added, the type of acid added, when the acid is added, adding strong acids, adding free radical inhibitors, terminating a reaction, slowing a reaction, increasing temperature, reducing temperature, adding vacuum, or a combination thereof. The process may vary the relative percent of unsaturation by causing retro-Michael addition. The process may vary the relative percent of unsaturation by increasing time period wherein Michael addition may occur. The relative percent of unsaturation may be about 40 or more, about 45 or more, about 50 or more, about 55 or more, about 65 or more, about 70 or more, about 75 or more, about 80 or more, or about 85 or more. The relative percent of unsaturation may be 100 or less, about 99 or less, about 95 or less, or about 92 or less. The percent unsaturation may be inversely proportional to an amount of ether moieties that are made via Michael addition to pendent alkene double bonds. The percent unsaturation may be determined by quantification of double bonds using nuclear magnetic resonance (NMR). The number of double bonds quantified in two of the different measurements taken herein may be compared to calculate a percent unsaturation. The method may include a step of determining a percent unsaturation after substantially all of starting methylene malonate is removed from the composition. The percent unsaturation and the percent saturation may equal 100 percent when added together. The percent unsaturation may be described as an alkene number.

The alkene number may function to illustrate the number of double bonds remaining or removed by Michael addition. Where diols are used to prepare the polyesters, the alkene number and percent unsaturation may provide a same number or percentage. Alkene number can be calculated from quantitative HNMR of methylene malonate polyesters, where a sample of the polyester with HMDSO standard is analyzed by HNMR spectroscopy in suitable deuterated solvent (i.e. CDCl3). Hexamethyldisiloxane (M.W. HMDSO, molecular weight is 162 g/mol) can be used as a standard when acquiring the HNMR spectra. The calculation for alkene value (mmol/g), which is the mmol of methylene malonate per 1 g of the polyester, can be performed using the following equation;

$$Alkene Value = \frac{Alkene CH 2 Peak Area}{Peak Area HMDSO} \times \frac{18}{2} \times \frac{m H MDSO}{m} \times \frac{1000}{M . W . H MDSO} ,$$

where Alkene CH₂ Peak Area is measured around 6.3 ppm and is a combined area for all methylene signals in this area; Peak Area HMDSO is measured as the reference at 0 ppm, 18 is the number of hydrogen nuclei in HMDSO and 2 is the number of hydrogen nuclei of the methylene malonate methylene group (CH2); m HMDSO is the weight of HMDSO in the sample, m is the weight of the polyester. To calculate the alkene number, theoretical alkene value (mmol/g), which is the mmol of methylene malonate methylene per 1 g of the polyester assuming no Michael adduct, is also needed. The following is the explanation about how to calculate theoretical alkene value. The polyester with no Michael adduct derived from the reaction between methylene malonate monomer (ROOC—C(═CH2)-COOR′) and diol (HO—X—OH) can be described as ROOC—C(═CH2)(—COO—X—OOC—C(═CH2)-)₍ₙ₋₁₎COOR′, where n is the number of the methylene malonate methylene functional groups per number average molecular weight of the polyester (Mn·polyester) assuming no Michael adduct. Because the polyester can be regarded as the combination of three parts, which are ROOC—C(═CH2)-COOR′, X₍ₙ₋₁₎ and (OOC—C(═CH2)-COO)₍ₙ₋₁₎, the number average molecular weight of the polyester (Mn) can be expressed by the following equation; Mn=M.W.monomer+M.W.X×(n−1)+114×(n−1), where M.W.monomer is the molecular weight of the monomer and M.W.X is the molecular weight of the linker of diol (X). By transforming this equation, n can be expressed by the following equation;

$$n = \frac{Mn . polyester - M . W . monomer + 114 + M}{114 + M . W . X} .$$

Theoretical alkene value (mmol/g) can be expressed as (n/Mn·polyester)×1000. Based on the equation above, this can be calculated as follows;

$$Theoretical alkene value ( \frac{m mol}{g} ) = \frac{Mn . polyester - M . W . monomer + 114 + M . W . X}{114 + M . W . X} \times \frac{1000}{Mn . polyester} .$$

Hereby, Alkene number can be calculated as;

$$Alkene number = \frac{Alkene Value}{Theoretical A lkene value} \times 100.$$

Disclosed is a polymerizable composition which prepares the polyesters disclosed herein. The polymerizable composition comprises one or more diols; one or more diesters wherein such diesters comprise one or more 1, 1-diester-1-alkenes; and one or more stabilizers comprising one or more of: oxo acids of phosphorous and esters thereof (phosphate esters), for instance pyrophosphoric acid, hypophosphoric acid, tripolyphosphoric acid, tetrapolyphosphoric acid, trimetaphosphoric acid, phosphoric anhydride; phosphate esters, aluminum sulfate; stannous pyrophosphate; stannous sulfate; and aluminum dihydrogenphosphate; wherein the composition forms one or more polyesters containing a chain of residue of the diols and diesters, and the chains have alkene groups incorporated into the chains. The phosphate esters have one or more of the acid groups of a phosphorus acid replaced with a hydrocarbyl group, for example an alkyl phosphate (ethyl phosphate), dialkyl phosphate (diethyl phosphate) or mixtures thereof. The oxo acids of phosphorous include phosphoric acid, pyrophosphoric acid, hypophosphoric acid, tripolyphosphoric acid, tetrapolyphosphoric acid, trimetaphosphoric acid. The one or more diesters may additionally comprise one or more hydrocarbylene dihydrocarbyl carboxylates. The composition may comprise one or more catalysts for transesterification of the diesters with the polyols.

The composition may comprise one or more polyols. The polyol a diol, a polyol, or a combination thereof. The polyols may be added to a mixture prior to transesterification. The polyols selected as reactants may be a di-, tri-, or poly-functional. The diols, polyols, or both may be reacted with the diesters so that transesterification proceeds. Some residual diols, polyols, or both may be present in the polyester, the composition, or both. Polyols may be compounds having a hydrocarbylene backbone with two or more hydroxyl groups bonded to the hydrocarbylene backbone and which may capable of transesterifying ester compounds under the transesterification conditions disclosed herein. The diols may be or include, 1,4-butanediol, propanediol, hexanediol, heptanediol, octanediol, nonandiol, 1,2-butanediol, ethylene glycol, propylene glycol or a combination thereof. Transesterification of the reactants may result in an ester-ester bonding, an ester-alcohol bonding, or a combination thereof. Polyols useful herein fall in two groups. The one group are diols with two hydroxyl groups bonded to a hydrocarbylene backbone and which function to initiate and extend the chains of the polyester. The second group being polyols with greater than two hydroxyl groups bonded to the hydrocarbylene backbone function to initiate more than two chains, although under certain conditions these polyols can function to chain extend the chains. The polyols having a functionality of three or more may form branches in the formed polyester chains. Diols may also function to branch and crosslink polyester chains. The one or more polyols may have 2 or more chains and the residue of one or more 1,1-disubstituted alkenes. The polyols may be any polyol which can be transesterified using the methods disclosed herein. The polyols may be any polyol which imparts elasticity to cured and/or crosslinked coatings, films and other structures prepared from compositions containing the polyesters. Long chain polyols may be used to prepare the polyesters. Exemplary long chain polyols include one or more polyether polyols, polysiloxane polyols, polycarbonate polyols, polyester polyols, epoxy polyols, or polybutadienyl polyols. The long chain polyols may be one or more polyether polyols, one or more polycarbonate polyols, or one or more polyester polyols. The long chain polyols may be di, tri, tetra, poly functional, or higher functional. The backbone for the polyols, including diols, may be alkylene, alkenylene, cycloalkylene, heterocyclylene, alkyl heterocyclylene, arylene, aralkylene, alkarylene, heteroarylene, alkheteroarylene, or polyoxyalkylene. The backbone may be C₁-C₁₅ alkylene, C₂-C₁₅ alkenylene, C₃-C₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The alkylene sections may be straight or branched. The recited groups may be substituted with one or more substituents that do not interfere with the transesterification reaction. Exemplary substituents include halo, alkylthio, alkoxy, hydroxyl, nitro, azido, cyano, acyloxy, carboxy, or ester. The backbone may be C₂₋₁₀ alkylene groups. The backbone may be a C₂₋₈ alkylene group, which may be straight or branched, such as ethylene, propylene, butylene, pentylene, hexylene, 2-ethyl hexylene, heptylene, 2-methyl 1,3 propylene or octylene. The diols having a methyl group at the 2 position of an alkylene chain may be used. Exemplary diols include ethanediols, propanediols, butanediols, pentanediols, hexanediol, 2-ethylhexyldiol, heptanediol, octanediol, nonandiol 2-methyl-1,3-propylene glycol, neopentyl glycol and 1,4-cyclohexanedimethanol. The diols may include one or more isomers. The diols may include two or more isomers. For example, propanediol may be 1,2-propanediol or 1,3-propanediol. The polyols may correspond to Chemical Structure 5

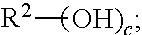

the diol may correspond to Chemical Structure 6: HO—R²—OH;
wherein R² is separately in each occurrence a hydrocarbylene group having two or more bonds to the hydroxyl groups of a polyol. R² may be separately in each occurrence alkylene, alkenylene, cycloalkylene, heterocyclylene, alkyl heterocyclene, arylene, aralkylene, alkarylene, heteroarylene, alkheteroarylene, or polyoxyalkylene. R² may be separately in each occurrence C₁-C₁₅ alkylene, C₂-C₁₅ alkenylene, C₃-C₉ cycloalkylene, C₂₋₂₀ heterocyclylene, C₃₋₂₀ alkheterocyclylene, C₆₋₁₈ arylene, C₇₋₂₅ alkarylene, C₇₋₂₅ aralkylene, C₅₋₁₈ heteroarylene, C₆₋₂₅ alkyl heteroarylene or polyoxyalkylene. The variable c can be one or more. The recited groups may be substituted with one or more substituents which do not interfere with uses of these compounds as disclosed herein. Exemplary substituents include halo, alkylthio, alkoxy, hydroxyl, nitro, azido, cyano, acyloxy, carboxy, or ester. R² may be separately in each occurrence a C₂₋₈ alkylene group, such as ethylene, propylene, butylene, pentylene, hexylene, 2-ethylhexylene, heptylene, 2-methyl-1,3-propylene or octylene. Exemplary C₃-C₉ cycloalkylenes include cyclohexylene. The alkylene groups may be branched or straight and may have a methyl group on the 2 carbon. Among preferred alkarylene polyols are polyols with the structure of -aryl-alkyl-aryl- (such as -phenyl-methyl-phenyl- or -phenyl-propyl-phenyl-) and the like. Among preferred alkyl cycloalkylene poly-yls are those with the structure of -cycloalkyl-alkyl-cycloalkyl-(such as -cyclohexyl-methyl-cyclohexyl- or -cyclohexyl-propyl-cyclohexyl-) and the like. The variable c may be an integer of 8 or less, 6 or less, 4 or less, or 3 or less and c may be an integer of 1 or greater, 2 greater or 3 or greater.

As used herein, diester refers to any compound having two ester groups which can be subjected to transesterification. A 1,1-diester-1-alkene is a compound that contains two ester groups and a double bond bonded to a single carbon atom referred to as the one carbon atom. Hydrocarbylene dihydrocarbyl carboxylates are diesters having a hydrocarbylene group between the ester groups wherein a double bond is not bonded to a carbon atom which is bonded to two carbonyl groups of the diester. The term “monofunctional” refers to the 1,1-diester-1-alkenes having only one core unit. The core unit comprises two carbonyl groups and a double bond bonded to a single carbon atom. The term “difunctional” refers to the 1,1-diester-1-alkenes having two core units (each including the reactive alkene functionality) bound through a hydrocarbylene linkage between one oxygen atom on each of two core formulas. The term “multifunctional” refers to the 1,1-diester-1-alkenes having two or more core units (each core unit including the reactive alkene functionality) bound together through a hydrocarbylene linkage between one oxygen atom on each of two or more core formulas.

1,1-diester-1-alkenes may be commonly referred to as methylene malonates. Compounds containing 1,1-dicarbonyl 1-alkenes are compounds that contain two carbonyl groups and a double bond bonded to a single carbon atom referred to as the one carbon atom. The carbonyl groups may be separately in each occurrence bonded to hydrocarbyl groups

The doubly bonded carbons may be part of an alkenyl group that is highly reactive. The alkenyl group may be a C₂₋₄ alkenyl group, or a methylene group (C═C). Only one of the carbon groups of the alkenyl group are bound to the carbonyl groups. The di-ester compounds contain hydrocarbyl groups bonded by an oxygen to the carbonyl groups wherein the hydrocarbyl groups may contain one or more heteroatoms, including heteroatom containing functional groups. The heteroatom functional groups may contain unsaturated groups that are capable of free radical or anionic polymerization. The hydrocarbyl groups bound directly to or indirectly to the carbonyl groups may be separately in each occurrence alkyl, alkenyl, cycloalkyl, heterocyclyl, alkyl heterocyclyl, aryl, aralkyl, alkaryl, heteroaryl, alkheteroaryl, or polyoxyalkylene, or both of the hydrocarbyl groups may form a 5-7 membered cyclic or heterocyclic ring. The hydrocarbyl groups may be separately in each occurrence C₁-C₁₅ alkyl, C₂-C₁₅ alkenyl, C₃-C₉ cycloalkyl, C₂₋₂₀ heterocyclyl, C₃₋₂₀ alkheterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene, or both hydrocarbyl groups form a 5-7 membered cyclic or heterocyclic ring. The recited groups may be substituted with one or more substituents, which do not interfere with the use of these compounds as described herein. Exemplary substituents include halo, alkylthio, alkoxy, hydroxyl, nitro, azido, cyano, acyloxy, carboxy, ester or unsaturated groups. The hydrocarbyl groups connected to the carbonyl group may be separately in each occurrence C₁-C₁₅ alkyl, C₃-C₆ cycloalkyl, C₄₋₁₈ heterocyclyl, C₄₋₁₈ alkheterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene. The hydrocarbyl groups connected to the carbonyl group may be separately in each occurrence a C₁₋₆ alkyl or cyclohexyl. The hydrocarbyl groups connected to the carbonyl group may be separately in each occurrence methyl, ethyl, propyl, butyl, pentyl, hexyl or cyclohexyl. The hydrocarbyl groups connected to the carbonyl group may be the same for each hydrocarbyl group on the 1,1-dicarbonylsubstituted-1-alkene compounds. Exemplary compounds are dimethyl, diethyl, ethylmethyl, dipropyl, dibutyl, dihexyl, dicyclohexyl, diphenyl, and/or ethyl-ethylgluconate malonates. The compounds may be dimethyl, diethyl, dihexyl, and/or dicyclohexyl methylene malonates. The 1,1-dicarbonyl substituted-1-alkenes can be prepared as disclosed in Malofsky et al., U.S. Pat. Nos. 8,609,885 8,884,051, 9,221,739 and 9,527,795; and Malofsky et al. U.S. Pat. No. 9,108,914.

The 1,1-dicarbonyl substituted-1-alkene compounds may correspond to Chemical structure 7:

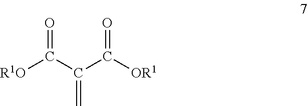

R¹ is separately in each occurrence a group that can undergo replacement or transesterification under the conditions of the methods disclosed herein. R¹ may be separately in each occurrence alkyl, alkenyl, cycloalkyl, heterocyclyl, alkyl heterocyclyl, aryl, aralkyl, alkaryl, heteroaryl, or alkyl heteroaryl, or polyoxyalkylene, or both R's form a 5-7 membered cyclic or heterocyclic ring. R¹ may be separately in each occurrence C₁-C₁₅ alkyl, C₂-C₁₅ alkenyl, C₃-C₉ cycloalkyl, C₂₋₂₀ heterocyclyl, C₃₋₂₀ alkyl heterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene, or both R¹ groups form a 5-7 membered cyclic or heterocyclic ring. The recited groups may be substituted with one or more substituents, which do not interfere with the uses of these compounds as disclosed herein. Exemplary substituents include halo alkylthio, alkoxy, hydroxyl, nitro, azido, cyano, acyloxy, carboxy, ester or unsaturated groups. R¹ may be separately in each occurrence C₁-C₁₅ alkyl, C₃-C₆ cycloalkyl, C₄₋₁₈ heterocyclyl, C₄₋₁₈ alkheterocyclyl, C₆₋₁₈ aryl, C₇₋₂₅ alkaryl, C₇₋₂₅ aralkyl, C₅₋₁₈ heteroaryl or C₆₋₂₅ alkyl heteroaryl, or polyoxyalkylene. R¹ may be separately in each occurrence a C₁₋₆ alkyl or C₅₋₆ cycloalkyl. R¹ may be separately in each occurrence methyl, ethyl, hexyl, or cyclohexyl. R¹ may be the same or different for each hydrocarbyl group on the 1,1-disubstituted alkene compounds.

The 1,1-dicarbonyl substituted alkene compounds may be methylene malonates which may correspond to Chemical Structure 8:

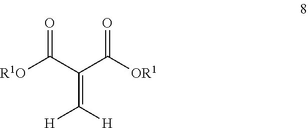

wherein R¹ is as described herein before.

The one or more 1,1-dicarbonyl substituted-1-alkenes may comprise one or more multifunctional, 1-dicarbonylsubstituted-1-alkenes. The one or more multifunctional, 1-dicarbonylsubstituted-1-alkenes include compounds which contain two or more 1,1-dicarbonyl 1-alkene groups, they may be difunctional compounds containing two 1,1-dicarbonyl 1-alkene groups or multifunctional compounds containing two or more 1,1-dicarbonyl 1-alkene groups. Such compounds may comprise two or more 1,1-dicarbonyl 1-alkene groups connected by the residue of a diol or polyol capable of transesterifying 1,1-dicarbonyl 1-alkenes. The multifunctional compounds may comprise a number of 1,1-dicarbonyl 1-alkenes linked by diols.

The one or more hydrocarbylene dihydrocarbylcarboxylates (dihydrocarbyl dicarboxylates) are compounds with two ester groups having a hydrocarbylene group disposed between the ester groups. The one or more hydrocarbylene dihydrocarbylcarboxylates comprise one or more of aromatic dicarboxylates, aliphatic dicarboxylates and cycloaliphatic dicarboxylates or may be one or more hydrocarbylene dihydrocarbylcarboxylates wherein one of the hydrocarbyl groups is aliphatic, cycloaliphatic or aromatic and the other is selected from another class of aliphatic, cycloaliphatic or aromatic. The one or more hydrocarbylene dihydrocarbylcarboxylates comprise one or more of aromatic dicarboxylates having 8 to 14 carbon atoms in the backbone, aliphatic dicarboxylates having 1 to 12 carbon atoms in the backbone and cycloaliphatic dicarboxylates having 8 to 12 carbon atoms in the backbone. The one or more hydrocarbylene dihydrocarbylcarboxylates comprise one or more malonates, terephthalates, phthalates, isophthalates, naphthalene-2,6-dicarboxylates, 1,3-phenylenedioxydiacetates, cyclohexane-dicarboxylates, cyclohexanediacetates, diphenyl-4,4′-dicarboxylates, succinates, glutarates, adipates, azelates, sebacates, or mixtures thereof. The one or more hydrocarbylene dihydrocarbylcarboxylates may comprise one or more malonates. The one or more hydrocarbylene dihydrocarbylcarboxylates correspond to the Chemical Structure 9:

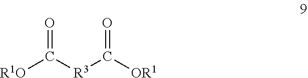

wherein R¹ is as previously described; and
R³ is separately in each occurrence a hydrocarbylene group having two bonds to the carbonyl groups of the diester wherein the hydrocarbylene group may contain one or more heteroatoms. R³ may be separately in each occurrence arylene, cycloalkylene, alkylene or alkenylene. R³ may be separately in each occurrence C₈₋₁₄ arylene, C₈₋₁₂ cycloalkylene, C₁₋₁₂ alkylene or C₂₋₁₂ alkenylene. R³ may be methylene.

The reactants may include one or more stabilizers. The stabilizer is present to stabilize the polymerizable composition and the polyester formed from undesired anionic polymerization.

The stabilizers may be acidic and may be less acidic than strong acids, that is have a pKa in an organic solvent of greater that the pKa of a strong acid. The stabilizers may be oxo acids of phosphorous or esters thereof, phosphate esters, aluminum sulfate, stannous pyrophosphate, stannous sulfate, aluminum dihydrogenphosphate or decomposition products thereof. The stabilizers may include: phosphoric acid, pyrophosphoric acid, hypophosphoric acid, tripolyphosphoric acid, tetrapolyphosphoric acid, trimetaphosphoric acid, phosphoric anhydride, aluminum sulfate, stannous pyrophosphate, stannous sulfate, aluminum dihydrogenphosphate, phosphate esters, or decomposition product thereof. The stabilizers may include; phosphoric acid, pyrophosphoric acid, hypophosphoric acid, tripolyphosphoric acid, tetrapolyphosphoric acid, trimetaphosphoric acid, phosphoric anhydride, phosphate esters or decomposition products thereof. The phosphate esters may be monoesters or diesters. The stabilizers may include: phosphoric acid, pyrophosphoric acid, phosphate esters or decomposition products thereof. The stabilizer may function only as an anionic stabilizer. The stabilizer may function as a secondary catalyst due to its acidic nature. Decomposition products thereof refer to any products formed form the stabilizer added to the reaction mixture or product which is altered as a result of the reaction or processing conditions. Where the stabilizer has multiple functional groups the decomposition product may contain the individual functional groups in a resulting compound. This may result from solvolysis of such a compound. For example pyrophosphoric acid has more than one group comprising a phosphorous atom doubly bonded to an oxygen atom and when pyrophosphoric acid decomposes it forms more than one compound having a group comprising a phosphorous atom doubly bonded to an oxygen atom wherein the phosphorous atom is further bonded to a hydroxyl group. It is desirable to have in the reaction mixture compounds having the reaction group comprising a phosphorous atom doubly bonded to an oxygen atom wherein the phosphorous atom is further bonded to a hydroxyl group. Such compound may function as a stabilizer. The stabilizer may be added with the strong acids. The stabilizer may be added in a total amount of about 1 ppm or more based on the weight of the polymerizable composition or the polyester depending on when it is added, about 20 ppm or more, about 50 ppm or more, about 70 ppm or more, or about 100 ppm or more. The stabilizer may be added in a total amount of about 1000 ppm or less based on the weight of the polymerizable composition or the polyester depending on when it is added, about 750 ppm or less, about 500 ppm or less, about 300 ppm or less, about 200 ppm or less, or about 110 ppm or less. The stabilizer may be added in one or more stages. As used in this context “about” means ±5 ppm. It may be desirable to have a residual amount of the stabilizer in the polyester formed. The residual amount may be an amount sufficient to prevent unwanted anionic polymerization and which does not prevent polymerization when it is contacted with an anionic polymerization initiator. The residual amount of the stabilizer may be selected such that the concentration of acid groups is less than the basic groups in an anionic polymerization initiator. The residual amount of stabilizer may be about 1000 ppm or less, about 500 ppm or less, about 200 ppm or less, 100 ppm or less or about 75 ppm or less. The residual amount of stabilizer may be about 1 ppm or greater or about 20 ppm or greater.

Known anionic stabilizers are acids and many of the acids typically used form esters under reaction conditions or in storage and the esters may not be effective anionic stabilizers. As a result of this phenomena, in known processes, excess acid is often added to the polymerizable composition and/or the compositions. The presence of excess acids can negatively impact polymerization of the polyesters formed. The stabilizer may be added to reduce the amount of strong acids added. An excess amount of the residual strong acid may be about 5 ppm or more, about 10 ppm or more, or about 20 ppm or more present in the polyester formed. The addition of the stabilizer may limit the total amount of residual strong acid in the polyesters formed to an amount of about 300 ppm or less, about 200 ppm or less or about 100 ppm or less in the polyester.

The polymerizable composition may comprise a transesterication catalyst. The transesterification catalyst may be an acid or an ester of such acid. The catalyst may be one or more acids. Acid catalyst, as used herein, is an acidic species that catalyzes the transesterification reaction while also catalyzing the Michael and retro-Michael addition reactions that accompany the synthesis of these polyesters. An acid may be used as a catalyst. The acids may be strong acids. The catalyst is an acid or an ester thereof. Any acid or ester thereof that catalyzes transesterification while minimizing side reactions may be used. Ester thereof, in the context of the acid catalysts, refer to compounds wherein at least one of the hydrogens on the acid is replaced with a hydrocarbyl group, for instance an alkyl group. Exemplary strong acids include mineral acids, sulfuric acid, sulfonic acids, trihaloacetic acids, triflated metal oxides, sulfated metal oxides.

Exemplary strong acids include trifluoromethanesulfonic acid (triflic acid), sulfated tin oxide, triflated tin oxide, sulfated zirconia, triflated zirconia, and triflated HZSM-5, fluorosulfonic acid, sulfuric acid or methanesulfonic acid, para-toluenesulfonic acid.

The one or more strong acids can be mixed with the reactants or can be supported on a substrate such as a membrane or an inert carrier such as a porous support structure (the catalysts can be heterogeneous). The strong acid can be used in any concentration that catalyzes the reaction of alcohols and ester compounds, such as 1,1-diester-1-alkene compounds, to replace the hydrocarbyl moiety on an ester group. The amount of strong acid utilized for the reaction depends on the type of strong acid and the reaction conditions of the process. The concentration of the strong acid may be about 5 molar equivalents or less per equivalent of the starting ester compounds as disclosed herein; about 3 molar equivalents or less; about 1 molar equivalent or less; or about 0.5 molar equivalents or less. The concentration of strong acid may be about 0.001 molar equivalents or greater per equivalent of ester compounds; about 0.0015 molar equivalents or greater. Higher concentrations of catalysts than recited may be utilized. The presence of strong acids in the polyesters formed can present problems with respect to use of the polyesters and low concentrations of residual strong acids in the polyesters is desired. If high levels of acid are contained in the polyester, additional purification or removal steps may be required. The amounts recited achieve the balance between efficient catalysis and the need for low strong acid concentrations in the polyesters.

The strong acid may be added in one or more stages. The strong acid can be used in any concentration that catalyzes the transesterification reaction and does not leave a residual amount of strong acid in the polyester formed which inhibits polymerization upon demand. The strong acid may be present in a polymerizable composition or used in an amount of about 300 ppm or less, about 200 ppm or less or about 100 ppm or less, about 75 ppm or less, 40 ppm or less, about 30 ppm or less, or about 20 ppm or less based on the amount of esters present in the polymerizable composition. The strong acids may be present in the polymerizable composition or used in an amount of about 10 ppm or more or about 15 ppm or more based on the amount of ester present in the polymerizable composition. The strong acid may be substantially completely converted into esters (e.g., about 20 ppm or less or about 10 ppm or less remain after transesterification) or completely converted into esters.

The polymerizable composition and/or the polyester formed composition may include one or more free radical inhibitors. The free radical inhibitors may be added before transesterification, after transesterification, before evaporation, after evaporation, to a final product, to a reaction product, or a combination thereof. Any free radical polymerization inhibitor that prevents free radical polymerization of the polymerizatiable composition, or the polyester formed, may be used. Exemplary free radical inhibitors include: tocopherol (e.g., including vitamin E), 4-tert-Butylpyrocatechol; tert-Butylhydroquinone; 1,4-Benzoquinone; 6-tert-Butyl-2,4-xylenol; 2-tert-Butyl-1,4-benzoquinone; 2,6-Di-tert-butyl-p-cresol; 2,6-Di-tert-butylphenol; Hydroquinone; 4-Methoxyphenol; Phenothiazine; 2,2′-methylenebis(6-tert-butyl-4-methylphenol) or a combination thereof. The free radical polymerization inhibitor may be an alkylated hydroxyanisole, an alkylated hydroxytoluene or mixtures thereof. The alkylated hydroxyanisole may be butylated hydroxyanisole (BHA) and the alkylated hydroxytoluene may be butylated hydroxytoluene (BHT). The free radical inhibitors may be a mixture of an alkylated hydroxyanisole and an alkylated hydroxytoluene. The alkylated hydroxyanisole and the alkylated hydroxytoluene may be added in a sufficient concentration or ratio to stabilize a polymerizable composition, the polyester, or both. The alkylated hydroxyanisole and the alkylated hydroxytoluene may be added in a ratio of about 1:2 to about 2:1. The polymerizable composition or formed polyester may include a sufficient amount of free radical stabilizer so that the stabilizer prevents free radical polymerization or further polymerization. The free radical stabilizer may be present in the polymerizable composition and/or polyester formed in an amount of about 20,000 ppm or less, about 15,000 ppm or less, about 10,000 ppm or less, or about 5,000 ppm or less. The free radical polymerization stabilizer may be present in the polymerizable composition or polyester formed in an amount of about 100 ppm or more, about 500 ppm or more or about 1,000 ppm or more.

The reactants may be liquid under transesterification reaction conditions and the components of the polymerizable composition may be contacted in neat form, without a solvent or dispersant. If the use of a solvent is desired, a solvent that does not react with the components of the polymerizable composition may be used. Another consideration in the choice of solvents is the boiling point of the solvent chosen. The solvent may have a boiling point of about 15° C. or higher, or about 20° C. or higher than the temperature at which the reaction is conducted. Aprotic solvents and long chain alkanes having a boiling point above the reaction temperature as described may be used; exemplary long chain alkanes are decane or dodecane.

One or more entrainer solvents may be added to the polymerizable composition to control or eliminate vaporization of the starting 1,1-diester-1-alkene. The entrainer solvents may reduce the loss of starting 1,1-diester-1-alkene into vapor, distillate, or both; be a solvent that assists in separating ethanol from starting 1,1-diester-1-alkene; or both. The 1,1-diester-1-alkene can volatilize during the reaction, which may lead to the 1,1-diester-1-alkenes polymerizing and/or polymer buildup as well as possible changes in reaction stoichiometry. To reduce or eliminate volatilization of 1,1-diester-1-alkenes an entrainer solvent may be added to the polymerizable composition. The entrainer solvent may be an aprotic hydrocarbon. The entrainer solvent may be hexane, toluene, xylene, anisole, an ether, heptane, octane, isobutane, pentane, isopentane, neopentane, nonane, decane, isoparaffin, or mixtures thereof. The entrainer solvent may be added in a sufficient amount to prevent the 1,1-diester-1-alkenes from polymerizing on the synthesis equipment and from being lost into distillate with byproducts of the polyester synthesis. The entrainer solvent may be added in a sufficient amount so that the byproducts formed during transesterification are removed without removal of the starting 1,1-diester-1-alkene. The entrainer solvent may be added in an amount of about 3 percent or more, about 5 percent or more, or about 8 percent or more of a total weight of the polymerizable composition. The entrainer solvent may be added in a suitable amount to keep about 20 percent or less, about 17 percent or less, about 15 percent or less, about 12 percent or less, or about 10 percent or less of the solvent with respect to the total weight of the polymerizable composition in a reactor.

The polyesters may be prepared by contacting one or more polyols with an equivalents excess of one or more diesters which includes one or more 1,1-diester 1-alkenes in the presence of a strong acid under conditions such that one or more polyesters are formed that contain the one or more polyols having two or more of their hydroxyl groups replaced with the residue of the diesters including one or more 1,1-diester 1-alkenes. The ratio of equivalents of ester groups of the one or more diesters including 1,1-diester 1-alkenes to hydroxyl groups of one or more polyols may be about 1:1 or greater or about 7:5 or greater. The ratio of equivalents of ester groups of one or more diesters including 1,1-diester 1-alkenes to hydroxyl groups of one or more polyols may be about 10:1 or less or about 3:1 or less. The choice of polyols may be used to control the number of chains in the polyester and/or to form the polyester chains in a controlled manner.

Transesterification is an equilibrium process and is typically performed under conditions to remove byproducts formed during the exchange, meaning the product formed by the hydrocarbyl moieties leaving the esters undergoing transesterification. The hydrocarbyl moieties leaving the ester group of the first ester compound may be smaller than the hydrocarbyl moieties replacing them so as to make the byproducts more volatile than the transesterified ester compounds and polyesters formed. The smaller byproducts will generally be more volatile than the transesterified ester compound and polyesters formed, which facilitates removal of the byproducts due to their volatile nature. The process disclosed can be used with any process conditions that remove the byproducts formed. Exemplary process conditions or steps that may be used to remove the byproducts formed may include one or more of the following: distillation, membrane transport, inert gas purge, application of a vacuum, utilization of entrainer solvent and the like.

The reactants may be contacted at any temperature at which transesterification proceeds. The reactants may be contacted at a temperature of about 80° C. or greater, about 100° C. or greater, about 125° C. or greater, or about 140° C. or greater or about 150° C. or greater. The reactants may be contacted at a temperature of about 200° C. or less, 175° C. or less, or about 160° C. or less. Transesterification may be performed at a temperature of about 20° C. or greater, about 35° C. or greater or about 40° C. or greater. Transesterification may be performed at a temperature of about 200° C. or less, about 175° C. or less or about 160° C. or less. The reactants may be mixed at ambient temperatures. After mixing the reactants, the reactants may be heated. Strong acids, solvents, stabilizers, entrainer solvents, or mixtures thereof may be added to the mixed reactants, the heated mixed reactants, or both.

The reactants are contacted for a sufficient time to prepare the polyester. The process may be performed such that the polyols, are substantially completely reacted with the diesters, such as a 1,1-diester-1-alkene compounds. The reactants may be contacted for about 1 hour or greater. The reactants may be contacted may be 24 hours or less or about 16 hour or less. The transesterification reaction may be performed at atmospheric pressure or under vacuum.

The strong acid and the stabilizer may be added together, in series or may be added in one or more steps or stages. The strong acid may be added before the stabilizer, after the stabilizer. The strong acid, the stabilizer, or both may be added in one or more steps, two or more steps, three or more steps, or five or more steps. The strong acid and stabilizer may be added in a total amount. The strong acid may be added as a charge, multiple charges, continuously, or a combination thereof. The strong acid may be added in an initial charge and then continuously. The strong acid may be added in a sufficient amount to prevent formation of cyclic ether byproducts such as tetrahydrofuran (which may form when 1,4-butanediol is used in transesterification). The strong acid may be added in a sufficient amount to begin the process, to enable transesterification to occur, enable effective retro-Michael addition to occur, to act as an anionic polymerization inhibitor, or a combination thereof. The strong acid may be in a sufficient amount to begin the transesterification process, enable effective transesterification to occur, or both. The strong acid may be added throughout the transesterification process in a sufficient amount so that the transesterification is continued or maintained. A sufficient amount of strong acid may be added so that retro-Michael addition effectively occurs.

A sufficient amount of the strong acid may be added to begin the transesterification to form the polyester, or both. The strong acid may be added in each stage in an amount of about 10 ppm or more, about 20 ppm or more, or 30 ppm or more. The strong acid may be added in each stage in an amount of about 50,000 ppm or less, about 30,000 ppm or less, or about 10,000 ppm or less based on the weight of the esters used in the polymerizable composition. The reaction mixture may have a sufficiently high level of catalyst so as to cause transesterification to occur (e.g., in an amount between about 100 ppm and about 50,000 ppm). The strong acid may be consumed during transesterification so that an amount of strong acid present in the final product is low when compared to the amount added throughout the process. The final product, the polyester may be free of strong acid. The polyester may include a residual amount of strong acid. The polyester may include about 1 ppm or more, about 5 ppm or more, or about 10 ppm or more of strong acid based on the weight of the polyester. The polyester may include about 300 ppm or less, about 200 ppm or less, or about 100 ppm or less of the strong acid based on the weight of the polyester. The addition of the strong acid may be varied depending on which stabilizer is selected or vice versa.

The stabilizer may be added in two stages. The stabilizer may be added in a first stage that introduces an amount that is greater than an amount in the subsequent stages alone or in combination. The stabilizer may be added during removal of the residual 1,1-diester-1-alkene. The stabilizer may be added during synthesis (e.g., transesterification), a first distillation, a second distillation, in a final product, in a storage container, or a combination thereof. The stabilizer may be added while the composition is being exposed to a wiped film evaporator processing, elevated temperature, vacuum, or a combination thereof (e.g., during a second distillation). Depending on when the stabilizer is added may affect how it controls a reaction, reacts with the composition, reacts with a reaction product, or a combination thereof. The stabilizer when added after a reaction product has been formed may stabilize the reaction product. The stabilizer may be separated after the reaction has been stopped, the composition is stabilized, or both. The stabilizer may be insoluble in the reaction product. If the stabilizer used is stannous sulfate or stannous pyrophosphate then the stabilizer may be removed in a separate stage or a second separation stage. The process discussed herein may be free of a step of removing some or all of the strong acid. The process may be free of a step of adding acidified alumina or some other composition to remove the strong acid. The composition may include a residual amount of strong acid, stabilizer, or both, about 300 ppm or less, 200 ppm or less, 100 ppm or less, or 1 ppb or more. The polyester may include a residual amount of the stabilizer. The polyester may include stabilizer in an amount of about 1 ppm or more, about 50 ppm or more, or about 100 ppm or more based on the weight of the polyester. The polyester may include an amount of stabilizer in an amount of about 6000 ppm or less, about 5000 ppm or less, or about 4000 ppm or less based on the weight of the polyester.

The method may include a step of adding or contacting a reaction product with one or more free radical polymerization inhibitors. The free radical polymerization inhibitors are disclosed hereinbefore. The method may include a step of adding free radical polymerization inhibitors to the reaction mixture, such as, or to the reaction product. When more than one stabilizer is added the stabilizers may be added in series, in parallel, in stages, or a combination thereof. The free radical stabilizers may be added (before, during, or after) into the reaction mixture, transesterification, distillation, the final product, or a combination thereof. The final composition may include a sufficient amount of free radical stabilizer so that the stabilizer prevents polymerization or further polymerization by free radical polymerization.

One or more entrainer solvents may be added to control or eliminate vaporization of the 1,1-diester-1-alkenes. The entrainer solvents may be added to a reaction mixture, a reaction product, or both. The entrainer solvent may be added to a gas phase, a first distillation, a second distillation, or a combination thereof. The entrainer solvents may reduce the loss of 1,1-diester-1-alkenes into vapor, distillate, or both. The entrainer solvents may assist in separating alcohols, for instance ethanol, from 1,1-diester-1-alkenes; or both. These 1,1-diester-1-alkenes can volatilize during the reaction, which may lead to the monomers polymerizing and/or polymer buildup as well as possible changes in reaction stoichiometry. To reduce or eliminate volatilization of 1,1-diester-1-alkenes an entrainer solvent may be added (e.g., above and/or below the liquid level) into the reaction mixture. The entrainer solvent may function to prevent the 1,1-diester-1-alkenes from evaporating, may prevent polymer buildup and also assist in removal of alcohols. The entrainer solvent may be added before or during the transesterification reaction of 1,1-diester-1-alkenes. The entrainer solvent may be added before or during heating of the reaction mixture. The entrainer solvent may be added before or during removal of by-products. The entrainer solvent may be added before or during distillation. The entrainer solvent may be added continuously throughout distillation of by-products formed. The entrainer solvent may only be added during a first distillation. The entrainer solvent may be added to prevent boiling or vaporization of 1,1-diester-1-alkenes. For example, the entrainer solvent may effectively reduce the level of 1,1-diester-1-alkenes in the gas phase and in their level in distillate can be drastically reduced, for example to 3 percent by weight or less. The entrainer solvent may be used with vacuum, without vacuum, with nitrogen or in a nitrogen environment. The entrainer solvent may be used with a nitrogen purge. The nitrogen purge may be used in place of vacuum, solvent, or both. The entrainer solvent may prevent the 1,1-diester-1-alkenes from polymerizing in the gas phase, in contact with surfaces of the reaction chambers or both. The entrainer solvent may be added only at the beginning of distillation, transesterification, or both. The entrainer solvent may be added throughout distillation, transesterification, or both. An initial amount of entrainer solvent may be added and then additional entrainer solvent may be added continuously to the system. The entrainer solvent may be added continuously.

The process disclosed may be performed in one or more steps. An example is to perform the transesterification in one step, removal of a portion of the solvent and by-products during the first step, completion of the removal of solvent and by-products during a second step and then removal of unreacted starting materials, such as 1,1-diester-1 alkenes, during a third step. Examples of the second and third steps are discussed hereinafter. The reaction product may be subjected to distillation, evaporation, or both to remove some of the excess components, unreacted components, volatile components, unwanted components, or a combination thereof. The reaction product may be distilled. The reaction product may be a product formed after some of the pre-cursor materials are partially or fully reacted. The reaction product may be subjected to an entrainer solvent before or during distillation. The reaction product may not be subjected to an entrainer solvent. The reaction product may be distilled in a condition that is vacuum free and entrainer solvent free. Distillation may occur under vacuum. Distillation may occur at ambient conditions (e.g., ambient pressure, ambient temperature, or both). Distillation may take place at an elevated temperature. Distillation may be pot distillation. Distillation may be continuous distillation. A wiped film evaporator (WFE) may be used to remove some components. The WFE may elevate a temperature of the reaction product, may be used while a temperature of a reaction product is elevated, or both. The temperature may be about 100° C. or more, about 120° C. or more, about 150° C. or more or about 200° C. or less. The WFE may be used while a vacuum is being applied. The vacuum may be about 0.1 mmHg or more, about 0.5 mmHg or more, about 1 mmHg or more, about 100 mmHg or less, or about 50 mmHg or less. The reaction product may be passed over the WFE a single time. The reaction product may be passed over the WFE 2, 3, 4, 5, or even 6 times. The reaction product may be passed over the WFE to remove some or all of the starting 1,1-diester-1-alkenes. The process may include a step of removing 1,1-diester-1-alkenes. The polyester, reaction product, or both may be passed over the WFE to remove residual 1, 1-diester-1-alkene. The polyester, reaction product, or both may be passed over the WFE a single time. The method may be free of a step of distilling the composition. The WFE may replace a step of distillation or may be used instead of distillation. Some or all of the starting 1, 1-diester-1-alkenes may be removed from the composition, the reaction product, the final product, or a combination thereof. The method may include a step of adding free radical stabilizers to the polyester, the reaction product, or both during contact with the WFE. The reaction product may be subjected to distillation, evaporation, or both to remove some of the excess components, unreacted components, volatile components, by-products, or a combination thereof. The reaction product may be distilled. The reaction product may be a product formed after some of the pre-cursor materials are partially or fully reacted. The reaction product may be distilled in a condition that is vacuum free and entrainer solvent free. Distillation may occur under vacuum. Distillation may occur at an elevated temperature. Distillation may be a pot distillation or continuous distillation. The reaction product, the polyester, the composition after the WFE, or a combination thereof may have an amount of starting 1, 1-diester-1-alkene that is about 1 percent or less, about 0.5 percent or less, about 0.1 percent or less, or about 0.05 percent or less by weight of the total weight of the reaction product, the polyester, the composition, or a combination thereof. The polyester, reaction product, or both may be passed over the WFE to remove residual 1, 1-diester-1-alkene. The polyester, reaction product, or both may be passed over the WFE a single time. The method may be free of a step of distilling the composition. The WFE may replace a step of distillation or may be used instead of distillation. The some or all of the starting 1, 1-diester-1-alkene may be removed from the composition, the reaction product, the final product, or a combination thereof.

The polyester compositions disclosed herein can be used to prepare coatings, films, fibers, particles and other structures. Such structures may be cured and or crosslinked. The crosslinked compositions may be crosslinked through the alkene groups pendant from the polyester chains. The crosslink may be a direct bond between the alkene groups of adjacent chains. The chains may be included in prepolymer or polymer chains. The chains may be crosslinked through any compound being unsaturated that polymerizes by anionic or free radical polymerization. The polyester chains may be crosslinked through 1,1-diester alkenes wherein the crosslinks comprise the residue of the 1,1-diester alkenes. The polyester chains may be crosslinked through multifunctional monomers wherein the crosslinks comprise the residue of the multifunctional monomers. The crosslink density of a crosslinked composition containing the polyesters may be any such density that provides the desired properties of the composition. The polyester chains may be crosslinked by Michael addition of a Michael Donor adding to alkene groups of two polyester chains. Cross linking in this context means that a number of polyester chains are connected by Michael addition through more than one diol or polyol to other polyester chains.

The polyesters formed may be branched by Michael addition of a diol or polyol which connects a polyester chain to another polyester chain. This branching may impact the following properties of the polyesters formed: viscosity, reactivity, miscibility with other components of formulations, dispersibility of other components of formulations, adhesion, mechanical and thermomechanical properties.

The polyesters and compositions containing them may undergo polymerization when exposed to basic cure initiators. If applied to the surface of a substrate that is basic the polyesters will cure via anionic polymerization. Polyesters and compositions containing the polyesters can undergo cure if contacted with a composition containing basic materials as a polymerization activator. The polymerization activator and methods of delivering the polymerization activator are disclosed in Malofsky U.S. Pat. No. 9,181,365, incorporated herein by reference in its entirety for all purposes. The polymerization activator may be at least one of a base, a base enhancer, a base creator, or a base precursor. The polymerization activator may comprise a basic material selected from a strong base (pH over 9), a moderately strong base (pH from 8-9), or a (mildly basic) weak base (pH from over 7 to 8), or a combination thereof. The polymerization activator may comprise a basic material selected from an organic material, an inorganic material or an organometallic material, or a combination thereof. The polymerization activator may be at least one member selected from: sodium acetate; potassium acetate; acid salts of sodium, potassium, lithium, copper, and cobalt; tetrabutyl ammonium fluoride, chloride, and hydroxide; an amine whether primary, secondary or tertiary; an amide; salts of polymer bound acids; benzoate salts; 2,4-pentanedionate salts; sorbate salts; propionate salts; secondary aliphatic amines; piperidine, piperazine, N-methylpiperazine, dibutylamine, morpholine, diethylamine, pyridine, triethylamine, tripropylamine, triethylenediamine, N,N-dimethylpiperazine, butylamine, pentylamine, hexylamine, heptylamine, nonylamine, decylamine; salts of amines with organic monocarboxylic acids; piperidine acetate; metal salt of a lower monocarboxylic acid; copper(II) acetate, cupric acetate monohydrate, potassium acetate, zinc acetate, zinc chloroacetate, magnesium chloroacetate, magnesium acetate; salts of acid containing polymers; salts of polyacrylic acid co-polymers, or pigments having a basic character. In certain embodiments, the polymerization activator is encapsulated in a wax, or is provided in inactive engagement with the polymerizable composition by chemical inactivation.

### Enumerated Embodiments

1. A composition comprising:

a. polyesters containing a chain of residue of: diols and diesters along the chain, wherein at least a portion of the diesters are 1, 1-diester-1-alkenes, and the chains have alkene groups incorporated into the chains;
b. the composition comprising one or more of the following:
i. ethers derived from alcohols, diols, polyols, or a combination thereof obtained via Michael addition to the alkene groups and a residue of the alkene groups remaining after Michael addition;
ii. the formed polyesters contain one percent or less of residual 1, 1-diester-1-alkene which are unreacted;
iii. one or more free radical inhibitors; and
iv. a stabilizer comprising one or more of: oxo acids of phosphorous or esters thereof, aluminum sulfate, stannous pyrophosphate, stannous sulfate, aluminum dihydrogenphosphate or decomposition products thereof.

2. The composition of Embodiment 1, wherein the one or more 1, 1-diester-1-alkenes are one or more 1,1-di-C₁₋₆ dialkylester-1-alkenes or C₅₋₆ cycloalkyl diester-1-alkenes.

3. The composition of Embodiment 1 or 2, wherein the stabilizer is added in an amount sufficient to enhance stability of the polyester without lowering reactivity of the polyester.

4. The composition according to any one of the preceding Embodiments wherein, the stabilizer is one or more of phosphoric acid, pyrophosphoric acid, hypophosphoric acid, tripolyphosphoric acid, tetrapolyphosphoric acid, trimetaphosphoric acid, phosphoric anhydride, aluminum sulfate, stannous pyrophosphate, stannous sulfate, aluminum dihydrogenphosphate, phosphate esters, and decomposition products thereof

5. The composition according to any one of the preceding Embodiments wherein, the composition contains one or more strong acids.

6. The composition according to any one of the preceding Embodiments, wherein the composition includes the one or more strong acids in an amount of about 300 parts per million or less.

7. The composition according to of any one of the preceding Embodiments, wherein the composition includes two or more free radical inhibitors.

8. The composition according to of the preceding Embodiments, wherein the free radical inhibitors are tocopherol, 4-tert-Butylpyrocatechol; tert-Butylhydroquinone; 1,4-Benzoquinone; 6-tert-Butyl-2,4-xylenol; 2-tert-Butyl-1,4-benzoquinone; 2,6-Di-tert-butyl-p-cresol; 2,6-Di-tert-butylphenol; Hydroquinone; 4-Methoxyphenol; Phenothiazine; 2,2′-methylenebis(6-tert-butyl-4-methylphenol), or a combination thereof.

9. The composition according to any one of the preceding Embodiments, comprising two or more free radical inhibitors wherein one is one or more alkylated hydroxyanisoles and the other is one or more alkylated hydroxytoluenes.

10. The composition according to any one of the preceding Embodiments, wherein the alkylated hydroxyanisole is butylated hydroxyanisole and the alkylated hydroxytoluene is butylated hydroxytoluene.

11. The composition according to any one of the preceding Embodiments, wherein the alkylated hydroxyanisole and alkylated hydroxytoluene are present in a ratio of about 1:2 to about 2:1.

12. The composition according to any one of the preceding Embodiments, wherein the stabilizer is pyrophosphoric acid, phosphoric acid, phosphate ester or a decomposition product thereof.

13. The composition according to any one of the preceding Embodiments, wherein the stabilizer is present in an amount of from about 1 parts per million to about 100 parts per million based on the weight of the composition.

14. The composition according to any one of the preceding Embodiments wherein the strong acid is present in a concentration of about 200 parts per million to about 1 part per billion based on the weight of the composition.

15 The composition according to any one of the preceding Embodiments wherein the strong acid is present in a concentration of about 100 parts per million to about 1 part per billion based on the weight of the composition.

16. The composition according to any one of the preceding Embodiments wherein the one or more strong acids is present in a concentration of about 100 parts per million or less and the one or more stabilizers are present in an amount of about 1 parts per million or more based on the weight of the composition.

17. The composition of any one of the preceding wherein the composition includes a sufficient amount of free radical stabilizer so that the free radical stabilizer prevents radical polymerization.

18. The composition according to any one of the preceding Embodiments, wherein the percent of the alkene groups present after Michael addition is about 55 or more.

19. The composition according to any one of the preceding Embodiments, wherein the percent of the alkene groups present after Michael addition is about 65 or more.

20. The composition according to any one of the preceding Embodiments, wherein the percent of the alkene groups present after Michael addition about 70 or more.

21. The composition according to any of the preceding Embodiments, wherein the percent of the alkene groups present after Michael addition is about 75 or more.

22. The composition according to any one of the preceding Embodiments, wherein the amount of unreacted 1, 1-diester-1-alkene present in the polyester is about 0.1 percent or less based on the weight of the composition.

23. The composition according to any one of the preceding Embodiments, wherein the amount of unreacted 1,1-diester-1-alkene is present in the polyester in an amount of about 0.05 percent or less by weight of a total weight of the polyester based on the weight of the composition.

24. A method comprising:

a. contacting one or more polyols with one or more 1,1-diester 1-alkenes in the presence of a stabilizer comprising one or more of oxo acids of phosphorous or esters thereof, aluminum sulfate, stannous pyrophosphate, stannous sulfate, aluminum dihydrogenphosphate, phosphate esters or decomposition products thereof: and
b. exposing the contacted compounds to conditions under which a composition comprising one or more polyesters according to any of preceding Embodiments are formed.

25. The method of Embodiment 24, wherein the stabilizer is one or more of phosphoric acid, pyrophosphoric acid, hypophosphoric acid, tripolyphosphoric acid, tetrapolyphosphoric acid, trimetaphosphoric acid, phosphoric anhydride, aluminum sulfate, stannous pyrophosphate, stannous sulfate, aluminum dihydrogenphosphate, phosphate esters and decomposition products thereof.

26. The method of Embodiment 24 or 25, wherein the one or more polyols and one or more 1, 1-diester 1-alkenes are contacted with a strong acid.

27. The method of any one of Embodiments 24 to 26, wherein the stabilizer is phosphoric acid, phosphate esters, pyrophosphoric acid or decomposition products thereof.

28. The method according to any one of Embodiments 24 to 27, wherein the strong acid is almost completely converted into esters.

29. The method according to any one of Embodiments 24 through 28, comprising removing the unreacted 1,1-diester 1-alkenes remaining after step a.

30. The method according to any one of Embodiments 24 through 29, wherein after removing the unreacted 1,1-diester 1-alkenes remaining after step a, the unreacted 1,1-diester 1-alkenes in the polyester are present in an amount of about 1.0 percent or less based on the weight of the composition.

31. The method according to any one of Embodiments 24 through 30, wherein after removing the unreacted 1,1-diester 1-alkenes remaining after step a, the unreacted 1,1-diester 1-alkenes are present in an amount of about 0.1 percent or less based on the weight of the composition.

32. The method according to any one of Embodiments 24 through 31, wherein after removing the unreacted 1,1-diester 1-alkenes remaining after step a, the unreacted 1,1-diester 1-alkenes are present in an amount of about 0.05 percent or less based on the weight of the composition.

33. The method according to any one of Embodiments 24 through 32, comprising removing a portion of the unreacted 1,1-diester 1-alkenes by distillation.

34. The method according to any one of Embodiments 24 through 33, wherein the polyester formed is passed through a Wiped Film Evaporator to remove a portion of the unreacted 1,1-diester-1-alkenes.

35. The method according to any one of Embodiments 24 through 34, comprising adding one or more free radical polymerization inhibitors to the polyester formed while the composition is passed through the wiped film evaporator.

36. The method according to any one of Embodiments 24 to 35, including applying vacuum to the polyester formed while passing it through the wiped film evaporator.

37. The method according to any one of Embodiments 24 through 36, comprising adding one or more free radical inhibitors to the reaction product.

38. The method according to any one of Embodiments 24 through 37, comprising adding an alkylated hydroxyanisole and an alkylated hydroxytoluene to the reaction product.

39. The method according to any one of Embodiments 24 through 38 wherein the alkylated hydroxyanisole is butylated hydroxyanisole and the alkylated hydroxytoluene is butylated hydroxytoluene and the butylated hydroxyanisole and the butylated hydroxytoluene are added to a reaction product of step (a).

40. The method according to any one of Embodiments 24 through 39, comprising removing, after step a, volatile by-products, unreacted 1,1-diester 1-alkenes, or both by elevating the temperature of the product.

41. The method according to any one of Embodiments 24 through 40, comprising applying a vacuum while the temperature of the product is elevated.

42. The method according to any one of Embodiments 24 through 41, wherein the one or more strong acids are present in an amount of about 300 parts per million or less in the final composition.

43. The method according to any one of Embodiments 24 through 42, wherein the stabilizer is pyrophosphoric acid, phosphoric acid, phosphate esters or decomposition product thereof and is present in step a in a concentration of about 1 parts per million or more based on the weight of the contacted ingredients.

44. The method according to any one of Embodiments 24 through 43, wherein the stabilizer is pyrophosphoric acid, phosphoric acid, phosphate esters or decomposition product thereof and is present in step a in a concentration of about 20 parts per million or more based on the weight of the contacted ingredients.

45. The method according to any one of Embodiments 24 through 44, comprising adding a second portion of pyrophosphoric acid, phosphoric acid or phosphate esters in the stabilizing step b.

46. The method according to 45, wherein the stabilizer is pyrophosphoric acid, phosphoric acid or phosphate esters and the stabilizer is added in a sufficient amount to stabilize the one or more polyesters without lowering reactivity of the one or more polyesters.

47. The method according to Embodiment 46, wherein the stabilizer is pyrophosphoric acid, phosphoric acid or phosphate esters and the stabilizer is added in a sufficient amount so that the final composition includes free pyrophosphoric acid that prevents polymerization.

48. The method according to any one of Embodiments 24 to 47, wherein the final composition has a percent of the alkene groups present after Michael addition of about 55 or more.

49. The method according to any one of Embodiments 24 through 47, wherein the final composition has a percent of the alkene groups present after Michael addition of about 65 or more.

50. The method according to any one of Embodiments 24 through 47, wherein the final composition has a percent of the alkene groups present after Michael addition of about 70 or more.

51. The method according to any one of Embodiments 24 through 47, wherein the final composition has a percent of the alkene groups present after Michael addition of about 75 or more.

52. The method according to any one of Embodiments 24 through 51, comprising determining the percentage of unsaturated bonds present after a portion of or substantially all of the unreacted 1,1-diester 1-alkenes are removed from the composition.

53. The method according to any one of Embodiments 24 to 52, wherein the stabilizer is present in the final composition in from about 1 parts per million to about 100 parts per million based on the weight of the starting materials.

54. The method according to any one of Embodiments 24 to 53, wherein the strong acid is present in a concentration of about 200 parts per million to about 1 part per billion.

55. The method according to any one of Embodiments 24 to 54 wherein the strong acid is present in a concentration of about 100 parts per million to about 1 part per billion based on the weight of the starting materials.

56. The composition according to any one of Embodiments 24 to 55 wherein the strong acid is present in a concentration of about 100 parts per million or less and wherein the stabilizer present in an amount of about 1 parts per million or more based on the weight of the starting materials based on the weight of the composition.

57. The method according to any one of Embodiments 24 through 56 comprising contacting the one or more polyols and one or more 1,1-diester 1-alkenes in step a with one or more alkylated hydroxyanisoles, one or more alkylated hydroxytoluenes, or both.

58. The method according to Embodiment 57, wherein the alkylated hydroxyanisole is butylated hydroxyanisole and the alkylated hydroxytoluene is butylated hydroxytoluene.

59. The method according to any one of Embodiments 24 through 58, comprising adding an entrainer solvent before distillation, continuously during distillation, or both.

60. The method according to any one of Embodiments 24 through 58, comprising adding the entrainer solvent as a single charge before or during the distillation.

61. The method according to any one of Embodiments 24 through 60, wherein the entrainer solvent is added during step a.

62. The method according to any one of Embodiments 24 through 61, comprising adding the stabilizer in an initial stabilizer charge and then a continuous charge or intermittent charge thereafter.

63. The method according to any one of Embodiments 24 through 62, comprising applying a vacuum to a reaction product before the reaction product is distilled.

64. The method according to any one of Embodiments 24 through 63, wherein the reaction product distilled without an addition of any entrainer solvents.

65. The method according to any one of Embodiments 24 through 64, comprising distilling the reaction product of step a free of vacuum and entrainer solvents.

66. A composition comprising:

one or more diols;
one or more diesters wherein such diesters comprise one or more 1, 1-diester-1-alkenes; and one or more stabilizers comprising one or more of oxo acids of phosphorous or esters thereof, aluminum sulfate, stannous pyrophosphate, stannous sulfate, aluminum dihydrogenphosphate, phosphate esters or decomposition products thereof;
wherein the composition forms one or more polyesters containing a chain of residue of the diols and diesters, and the chains have alkene groups incorporated into the chains.

67. The composition of Embodiment 66, wherein the stabilizer is one or more of phosphoric acid, pyrophosphoric acid, hypophosphoric acid, tripolyphosphoric acid, tetrapolyphosphoric acid, trimetaphosphoric acid, phosphoric anhydride, aluminum sulfate, stannous pyrophosphate, stannous sulfate, aluminum dihydrogenphosphate, phosphate esters and decomposition products thereof.

68. The composition of Embodiment 66 or 67, wherein the 1, 1-diester-1-alkenes comprise one or more 1,1-di-C₁₋₆ dialkylester-1-alkenes and 1,1-di-C₅₋₆ cycloalkylester-1-alkenes.

69. The composition according to any one of Embodiment 66 to 68, wherein the stabilizer is added in an amount sufficient to enhance stability of the polyester without lowering reactivity of the polyester.

70. The composition according to any one of Embodiments 66 to 69 wherein the composition contains one or more strong acids.

71. The composition according to any one of Embodiments 66 to 70, wherein the composition includes the strong acid in an amount of about 300 parts per million to about 1 part per billion.

72. The composition according to any one of Embodiments 66 to 71, wherein the composition includes one or more free radical inhibitors.

73. The composition according to any one of Embodiments 66 to 72, wherein the composition includes two or more free radical inhibitors.

74. The composition according to any one of Embodiments 66 or 73, wherein the free radical inhibitor comprises one or more of tocopherol, 4-tert-Butylpyrocatechol; tert-Butylhydroquinone; 1,4-Benzoquinone; 6-tert-Butyl-2,4-xylenol; 2-tert-Butyl-1,4-benzoquinone; 2,6-Di-tert-butyl-p-cresol; 2,6-Di-tert-butylphenol; Hydroquinone; 4-Methoxyphenol; Phenothiazine; 2,2′-methylenebis(6-tert-butyl-4-methylphenol), or a combination thereof.

75. The composition according to any one of Embodiments 72 to 74, wherein the two or more free radical inhibitors comprise an alkylated hydroxyanisole and an alkylated hydroxytoluene.

76. The composition according to any one of Embodiments 66 to 75, wherein the free radical stabilizer is alkylated hydroxyanisole is butylated hydroxyanisole and the alkylated hydroxytoluene is butylated hydroxytoluene.

77. The composition according to any one of Embodiments 66 to 76, wherein the alkylated hydroxyanisole and alkylated hydroxytoluene are present in a ratio of about 1:2 to about 2:1.

78. The composition according to any one of Embodiments 66 to 77, wherein the stabilizer is pyrophosphoric acid, phosphoric acid, phosphate esters or a decomposition product thereof.

79. The composition according to any one of Embodiments 66 to 78, wherein the stabilizer is present in an amount of about 1 parts per million to about 100 parts per million based on the weight of the composition.

80. The composition according to any one of Embodiments 66 to 79 wherein the strong acid is present in a concentration of about 200 parts per million to about 1 part per billion based on the weight of the composition.

81. The composition according to any one of Embodiments 66 to 80 wherein the strong acid is present in a concentration of about 100 parts per million to about 1 part per billion based on the weight of the composition.

82. The composition according to any one of Embodiments 66 to 81 wherein the one or more strong acids is present in a concentration of about 100 parts per million or less and the one or more stabilizers are present in an amount of about 1 parts per million or more based on the weight of the composition.

83. The composition according to any one of the Embodiments 66 to 82 wherein the composition includes a sufficient amount of free radical stabilizer so that the free radical stabilizer prevents free radical polymerization.

### ILLUSTRATIVE EMBODIMENTS

The following examples are provided to illustrate the teachings herein and are not intended to limit the scope thereof. All parts and percentages are by weight unless otherwise indicated. The Diethyl methylene malonate (DEMM) contains 3500 ppm butylated hydroxytoluene. No additional BHT is added in the examples, unless specifically stated. Molecular weights in the examples are weight average molecular weights determined using GPC using polymethyl methacrylate standards, unless otherwise specified.

### Example 1

A 2 L two part jacketed reactor (available from IKA company) with heating oil in the jacket connected to a circulating heating bath is equipped with anchor blade stirrer, thermocouples, a condenser, a distillation adapter, a vacuum adapter, a distillate receiver and a vacuum pump. Diethyl methylene malonate (DEMM, 1000 g), 1,4-butanediol (275 g), 98% sulfuric acid (1 g or 1000 ppm, with respect to DEMM), and butylated hydroxyanizole (BHA, 2.5 g) are charged into the reactor at ambient temperature and stirred until all solids have been dissolved. The reaction mixture is heated to 135° C. TO time of the reaction is based on when the reaction mixture reaches 135° C. Vacuum is then gradually applied while controlling the reflux to prevent excessive loss of DEMM into distillate and the pressure is decreased from ambient to first 230 Torr and ultimately to 80 Torr. The reaction temperature is also gradually increased from 135° C. to 150° C. Samples are taken from the reaction mixture each hour after TO and the following parameters are measured and recorded: weight average molecular weight by GPC (Mw, Da), percent of high molecular weight area in GPC (HMW, %), alkene number is measured by quantitative NMR in CDCl₃ using hexamethyldisiloxane (HMDSO) as a standard, sulfuric acid levels are measured by ion chromatography and are reported in ppm for the reaction mixture. The reaction sample measurements can be found in Table 1. When the reaction mixture approaches the 14^{th} hour (T14) its viscosity significantly increases and despite rapid lowering of the temperature the reaction gels.

### Example 2

The reactor as described in Example 1 is used in this Example. Diethyl methylene malonate (DEMM, 1000 g), 1,4-butanediol (275 g), 98% sulfuric acid (1 g or 1000 ppm, with respect to DEMM), butylated hydroxyanisole (BHA, 2.5 g) and pyrophosphoric acid (0.1 g or 100 ppm with respect to DEMM) are charged into the reactor at ambient temperature and stirred until all solids have been dissolved. The same reaction profile as in the Example 1 is followed and samples are taken every hour (Table 1).

Table 1 shows that the Example 1 reaction proceeds smoothly for the first 7 hours and the alkene number reaches 77. A sample of the reaction mixture is collected and anionically initiated using 0.1 wt % sodium benzoate solution in ethanol and is found to rapidly polymerize. This, coupled with the measurements of residual sulfuric acid by ion chromatography, confirms that the level of strong acid stabilization against anionic polymerization is very low at this point. After this the alkene number begins to decrease and the amount of high molecular weight species begins to increase, indicating polymerization through the methylene groups of the methylene malonate. The low level of anionic stabilization eventually results in the gelation of the reaction mixture at the 14^{th} hour before the desired high alkene number of 80 is achieved. In comparison, Example 2 shows that an alkene number of 80.9 is reached at the 8^{th} hour while the level of polymeric species remains low and reaction maintains the desired alkene number above 80 until the 14^{th} hour. This shows that the addition of pyrophosphoric acid markedly improves the stability of the reaction mixture and allows attainment of high alkene numbers without destabilizing the reaction mixture. A reaction sample taken at the 14^{th} hour is cured using 0.1% sodium benzoate initiation and shows rapid reactivity, meaning that the desired combination of high alkene number, high reactivity and high stability are obtained.

TABLE 1
Comparison of Reactions with (Example 2) and without
(Example 2) Pyrophosphoric Acid Stabilization.

| | | | | | Example 2 pyrophosphoric | | | |
|---|---|---|---|---|---|---|---|---|
| | Example 1 | | | | acid, 100 ppm | | | |
| Reaction | | HMW, | | | | HMW, | | |
| Time | | GC | | | | GC | | |
| from | Alkene | area | Mw, | H₂SO₄, | Alkene | area | Mw, | H₂SO₄, |
| T0, h | # | % | Da | ppm | # | % | Da | ppm |
| 2 | 33.5 | | | | | | | |
| 4 | 61.0 | — | 1505 | 30 | 66.7 | | | |
| 7 | 77.0 | | | <5 | | | | 57 |
| 8 | 76.7 | 2.0 | 2043 | <5 | 80.9 | 2.2 | 1390 | <5 |
| 10 | 69.8 | 5.1 | 3916 | <5 | 79.9 | 2.7 | 1442 | <5 |
| 11 | 68.2 | 5.6 | 4769 | <5 | | | | |

| | | | | | |
|---|---|---|---|---|---|
| 14 | gel | 81.0 | 3.5 | 1529 | <5 |

### Example 3

The reaction setup from Example 1 is used. The reactor is charged with DEMM (1000 g), 1,4-butanediol (275 g), paratoluenesulfonic acid (PTSA, 8.3 g), BHA (2.5 g), and pyrophosphoric acid (0.1 g). The reaction samples are taken as in Example 1 and the data is found in Table 2.

### Example 4

The reaction setup from Example 1 is used. The reactor is charged with DEMM (1000 g), 1,4-butanediol (275 g), methanesulfonic acid (MSA, 4.2 g), BHA (2.5 g), and pyrophosphoric acid (0.1 g). The reaction samples are taken as in Example 1 and the data is found in Table 2.

TABLE 2
Reaction with other strong acid.

| | Example 3 (PTSA) | | | | Example 4 (MSA) | | | |
|---|---|---|---|---|---|---|---|---|
| Reaction | | HMW, | | | | HMW, | | |
| Time | | GPC | | | | GPC | | |
| from | Alkene | area | Mw, | pTSA, | Alkene | area | Mw, | MSA, |
| T0, h | # | % | Da | ppm | # | % | Da | ppm |
| 2 | 44.4 | | | | | | | |
| 4 | 74.1 | | | 4886 | 73.2 | | | 2112 |
| 7 | 80.9 | 1.2 | 1465 | 33 | 80.0 | 2.2 | 1666 | 41 |
| 9 | 80.8 | 1.4 | 1580 | 23 | 79.5 | 3.3 | 1717 | 25 |
| 12 | 83.2 | 2.9 | 1766 | 10 | 79.9 | 4.6 | 1855 | 12 |

Alkene numbers at or near 80 are obtained using pyrophosphoric acid stabilization with PTSA and MSA catalysis. The small level of pyrophosphoric acid suppresses the anionic polymerization even when PTSA and MSA residual levels are very low. The reaction mixture samples are also taken at the 12^{th} hour and are found to rapidly cure when contacted with a 0.1% sodium benzoate solution in ethanol. This indicates the reaction product still has high reactivity while maintaining stability and low high molecular weight species formation.

### Example 5

The same reactor setup is used as in Example 1. The reactor is charged with DEMM (1000 g), 1,4-Butanediol (275 g), sulfuric acid (1 g), BHA (2.5 g) and pyrophosphoric acid (0.1 g). The reaction is run similarly to Example 1. Upon completion of the reaction residual DEMM is removed to less than 10,000 ppm using wiped film evaporator (WFE). The WFE is a 2 inch diameter glass setup equipped with cold finger and peristaltic feed pump. The oil temperature for WFE body is set to 110° C. and the pressure is set to 0.6 to 1.0 Torr. The feed rate is 400 ml/hr. The product is then analyzed for weight average molecular weight and high molecular weight polymer fraction by GPC, alkene number is determined using quantitative NMR, sulfuric acid levels are measured using ion chromatography and viscosity is measured on a Rheometer at 25° C.

### Example 6

The same reactor setup is used as in Example 1.

The reactor is charged with DEMM (1000 g), 1,4-Butanediol (403 g), sulfuric acid (1 g), BHA (2.5 g) and pyrophosphoric acid (0.1 g). The reaction is run similarly to Example 1. Upon completion of the reaction residual DEMM is removed to less than 10,000 ppm using a wiped film evaporator (WFE) and the product is analyzed using the same methods as in Example 5.

### Example 7

The same reactor setup is used as in Example 1.

The reactor is charged with DEMM (1000 g), 1,4-Butanediol (476 g), sulfuric acid (1 g), BHA (2.5 g) and pyrophosphoric acid (0.1 g). The reaction is run similarly to Example 1. Upon completion of the reaction residual DEMM is removed to less than 10,000 ppm using a wiped film evaporator (WFE) and the product is analyzed using the same methods as in Example 5.

TABLE 3
Purified Polyester from 1,4-Butanediol using Varied Stoichiometry

| | | | DEMM; | | HMW, | | Vis- | |
|---|---|---|---|---|---|---|---|---|
| | DEMM, | 1,4-BDO, | 1,4-BDO, | Alkene | GPC | Mw, | cosity, | H₂SO₄, |
| Example | g | g | molar ratio | # | area % | Da | cP | ppm |
| 5 | 1000 | 275 | 1.9 | 67.6 | 1.4 | 1408 | 209 | <5 |
| 6 | 1000 | 403 | 1.3 | 71.3 | 0.9 | 2389 | 357 | <5 |
| 7 | 1000 | 476 | 1.1 | 65.3 | 0.9 | 3300 | 710 | <5 |

Decreasing the molar ratio of DEMM to 1,4-butanediol results, in the increased molecular weight of the synthesized polyesters. The addition of 100 ppm of pyrophosphoric acid to the reaction also suppresses anionic polymerization and provides sufficient stabilization to obtain higher molecular weight polyesters, see Examples 5, 6 and 7. These polyesters are all rapidly cured using 0.1% sodium benzoate initiation, which indicates they have the desired balance of high reactivity and stability.

### Example 8. Procedure for Solvent Entrainer

A 2 part 10 liter jacketed reactor (connected to an oil circulator bath and equipped with a stirrer, distillation condenser and adapters, thermocouples and a solvent pump) is charged with DEMM (7 kg), 1,4-Butanediol (1.925 kg), MSA (29.4 g) and pyrophosphoric acid (0.7 g). Toluene (1.2 L) is loaded into the solvent pump and fed continuously at 0.5 L/h rate for 14 hours. The reaction is heated to 135° C. followed by a gradual increase of temperature to 150° C. The reaction is run under ambient pressure without applying vacuum and is compared with Example 9 in Table 4.

### Example 9. A Comparison Synthesis Using Vacuum Process

A 2 part 10 liter jacketed reactor connected to oil circulator bath and equipped with stirrer, distillation condenser and adapters, thermocouples is charged with DEMM (7 kg), 1,4-Butanediol (1.925 kg), MSA (29.4 g) and pyrophosphoric acid (0.7 g). This reaction is performed without the use of a solvent the reaction is heated to 135° C. followed by a gradual increase of temperature to 150° C. Vacuum is applied and the pressure is gradually reduced to 80 Torr through the end of the reaction. The results are reported in Table 4 and compared with Example 8 results.

TABLE 4
Polyester Synthesis using Solvent Entrainer.

| | | Polymer | | | | | |
|---|---|---|---|---|---|---|---|
| | | | HMW, | | Distillate | | |
| | | Alkene | GPC | Mw, | Ethanol, | DEMM, | Toluene, |
| Example | Solvent | # | area % | Da | g | g | g |
| 8 | Toluene | 81.2* | 1.5 | 1606 | 1374 | 337 | 6016 |
| 9 | None | 80.3 | 2.1 | 1585 | 1316 | 1106 | — |

Alkene # was measured by NMR after toluene was removed by distillation at 70° C. and 10Torr.

Table 4 shows the vacuum process results in a relatively large loss of DEMM into distillate. With the use of toluene as the entrainer solvent the loss of DEMM into distillate is significantly reduced while the removal of ethanol is nearly the same. This results in much better control of the molecular weight for the polyester. The use of entrainer solvent drastically reduces the quantity of DEMM in the gas phase, which either effectively eliminates or significantly reduces any polymer buildup on the distillation surfaces. The same high alkene number and high reactivity of the reaction product are also achieved. This also demonstrates that the reaction could be scaled up from 1 kg DEMM to 7 Kg without increasing polymer buildup and while maintaining the desired product properties.

### Example 10. Synthesis with Monoethylphosphate and Diethylphosphate as Stabilizers

A 1 L glass reactor is equipped with an anchor blade stirrer, oil bath, thermocouples, distillation adapter, condenser and distillate receiver. The reactor is charged with DEMM (300 g), 1,4-Butanediol (82 g), MSA (1.6 g), 0.07 g of the mixture of ethylphosphate and diethylphosphate. The reaction is heated to 150° C. and run at ambient pressure using toluene (140 g) as an entrainer solvent. Toluene is added over 10 hours in 10 g/h portions.

### Example 11. Synthesis with Phosphoric Acid as Stabilizer

A 1 L glass reactor is equipped with an anchor blade stirrer, an oil bath, thermocouples, distillation adapter, condenser and distillate receiver. The reactor is charged with DEMM (300 g), 1,4-Butanediol (82 g), MSA (1.6 g), 0.038 g of phosphoric acid. The reaction mixture is heated to 150° C. and run at ambient pressure using toluene (265 g) as an entrainer solvent. Toluene is added over 13 hours in 10 g/h portions.

For Examples 10 and 11 the level of MSA is measured using capillary electrophoresis. The data is summarized in Table 5.

TABLE 5
Polyester Synthesis with Phosphoric Acid and its Partial Esters.

| | Example 10 (partial ethyl | | | | Example 11 | | | |
|---|---|---|---|---|---|---|---|---|
| | esters of phosphoric acid) | | | | (phosphoric acid) | | | |
| | | HMW, | | | | HMW, | | |
| Reaction | | GPC | | | | GPC | | |
| Time, | Alkene | area | Mw, | MSA, | Alkene | area | Mw, | MSA, |
| h | # | % | Da | ppm | # | % | Da | ppm |
| T1 | | 0.6 | 787 | | | 0.9 | 968 | 4060 |
| T4 | | 0.3 | 1012 | | | 0.2 | 1243 | 3726 |
| T7 | | 0.8 | 1071 | | | 0.6 | 1212 | 3037 |
| T11 | | 2.1 | 1071 | | | 1.5 | 1075 | 1560 |
| T12 | | 2.2 | 1048 | 643 | | 1.5 | 1066 | 1031 |
| T13 | | 2.8 | 1085 | 93 | | 2.4 | 1049 | 527 |
| T14 | 79.1* | 3.4 | 1146 | 11 | | 4.1 | 1152 | 84 |
| T16 | — | — | — | — | 80.9* | 4.5 | 1194 | 2 |

*Alkene # is measured by NMR after toluene is removed by WFE distillation at 2Torr with heating to 140° C. using an oil bath.

Table 5 shows the mixture of ethylphosphate and diethylphosphate, as well as phosphoric acids, can suppress anionic polymerization even after MSA has been almost completely consumed. The reaction sample at the end of each reaction is tested for cure with 0.1% sodium benzoate solution and are found to rapidly cure. The polyester is synthesized with a low high molecular weight fraction, without any gels and with high reactivity.

### Example 12. Polyester from 1,6-Hexanediol

A round bottom 300 mL flask is equipped with a stirring bar, condenser, distillation adapters, and thermocouples. The flask is heated using oil bath. The flask is charged with DEMM (160 g), 1,6-Hexanediol (66 g), MSA (0.7 g), and pyrophosphoric acid (0.016 g). Toluene is used as entrainer solvent and is fed continuously from the beginning (16 g) to the end of the reaction over 12 hours in 10 g/h portions. The reaction mixture is heated to 150° C. and maintained at this temperature until its end. The reaction product is then passed through WFE (140° C.) in two passes (first pass pressure is 2 Torr and second pass pressure is 0.6-1 Torr) to remove residual DEMM to less than 10,000 ppm after the first pass and less than 1000 ppm after the second pass. The polyester is then analyzed by GPO for molecular weight and high molecular weight fraction, by quantitiative NMR for alkene number and by capillary electrophoresis for MSA level.

### Example 13. Polyester from Triethyleneglycol

The same reaction setup as in Example 12 is used. The flask is charged with DEMM (160 g), triethyleneglycol (84.7 g), MSA (1.44 g), and pyrophosphoric acid (0.016 g). Toluene is used as entrainer solvent and fed continuously from the beginning (16 g) to the end of the reaction over 17 hours at 10 g/h portions. The reaction mixture is heated to 150° C. and maintained at this temperature until the end of the reaction. The reaction product is purified in the same manner as in Example 12.

### Example 14. Polyester from 1,9-Nonanediol

The same reaction setup is used as in Example 10. The flask is charged with DEMM (300 g), 1,9-nonanediol (167 g), MSA (2.4 g), and mixture of ethylphosphate with diethylphosphate (0.07 g). Toluene is used as entrainer solvent and is fed continuously from the beginning (16 g) to the end of the reaction over 10 hours in 15 g/h portions. The reaction mixture is heated to 150° C. and maintained at this temperature until its end. The reaction product is purified in the same manner as in Example 12.

### Example 15. Polyester from Cyclohexanedimethanol

A round bottom 500 mL flask is equipped with a stirring bar, condenser, distillation adapters, and thermocouples. The flask is heated using oil bath. The flask is charged with DEMM (300 g), cyclohexanedimethanol (100.54 g), MSA (3.58 g), and pyrophosphoric acid (0.045 g). Heptane is used as entrainer solvent and fed continuously from the beginning (10.0 g) to the end of the reaction over 11 hours at 15.2 g/h portions. The reaction mixture is heated to 150° C. and maintained at this temperature until the end of the reaction. The reaction product is purified in the same manner as in Example 12.

### Example 16. 3-Methyl-1,5-pentanediol

The same reaction setup as in Example 15 is used. The flask is charged with DEMM (300 g), 3-Methyl-1,5-pentanediol (123.54 g), MSA (2.21 g), and pyrophosphoric acid (0.053 g). Toluene is used as entrainer solvent and fed continuously from the beginning (30 g) to the end of the reaction over 11 hours at 15.6 g/h portions. The reaction mixture is heated to 150° C. and maintained at this temperature until the end of the reaction. The reaction product is purified in the same manner as in Example 12.

### Example 17. 2,2-Dimethyl-1,3-propanediol

The same reaction setup as in Example 12 is used. The flask is charged with DEMM (160 g), 2,2-Dimethyl-1,3-pentanediol (58 g), MSA (2.65 g), and pyrophosphoric acid (0.07 g). Toluene is used as entrainer solvent and fed continuously from the beginning (16 g) to the end of the reaction over 12 hours at 15 g/h portions. The reaction mixture is heated to 150° C. and maintained at this temperature until the end of the reaction. The reaction product is purified in the same manner as in Example 12.

### Example 18. Neopenthyl Glycol Mono(hydroxypivalate)

The same reaction setup as in Example 12 is used. The flask is charged with DEMM (160 g), Neopenthyl glycol mono(hydroxypivalate) (62 g), MSA (2.65 g), and pyrophosphoric acid (0.14 g). Toluene is used as entrainer solvent and fed continuously from the beginning (16 g) to the end of the reaction over 18 hours at 15 g/h portions. The reaction mixture is heated to 150° C. and maintained at this temperature until the end of the reaction. The reaction product is purified in the same manner as in Example 12.

### Example 19. Cyclohexanedimethanol and 1,6-Hexanediol

The same reaction setup as in Example 12 is used. The flask is charged with DEMM (160 g), cyclohexanedimethanol (39.8 g), 1,6-hexanediol (3.6 g), MSA (1.5 g), and pyrophosphoric acid (0.14 g). Toluene is used as entrainer solvent and fed continuously from the beginning (16 g) to the end of the reaction over 10 hours at 15 g/h portions. The reaction mixture is heated to 150° C. and maintained at this temperature until the end of the reaction. The reaction product is purified in the same manner as in Example 12.

### Example 20. Cyclohexanedimethanol and 1,9-Nonanediol

The same reaction setup as in Example 12 is used. The flask is charged with DEMM (180 g), cyclohexanedimethanol (54.3 g), 1,9-nonanediol (6.7 g), MSA (1.7 g), and pyrophosphoric acid (0.04 g). Toluene is used as entrainer solvent and fed continuously from the beginning (18 g) to the end of the reaction over 10 hours at 15 g/h portions. The reaction mixture is heated to 150° C. and maintained at this temperature until the end of the reaction. The reaction product is purified in the same manner as in Example 12.

The properties of the polyesters synthesized from different diols are summarized in Table 6. Each of the polyesters are rapidly cured with 0.1% sodium benzoate solution in ethanol, indicating the desired high reactivity is obtained.

TABLE 6
Polyester Synthesis from Various Diols

| | | DEMM; | | | | Vis- | |
|---|---|---|---|---|---|---|---|
| | | Diol, | | HMW, | | cosity | |
| Exam- | | molar | Alkene | GPC | Mw, | @25°, | MSA, |
| ple | Diol | ratio | # | area % | Da | cP | ppm |
| 12 | Hexanediol | 1.66 | 76 | 1.8 | 2038 | 442 | 25 |
| 13 | Triethylene | 1.65 | 69 | 3.8 | 2079 | 845 | 9 |
| | glycol | | | | | | |
| 14 | Nonanediol | 1.66 | 81 | 4.6 | 2712 | 442 | 14 |
| 15 | Cyclohexane- | 2.5 | 83 | 3.4 | 1109 | 2150 | 4 |
| | dimethanol | | | | | | |
| 16 | 3-methyl- | 1.66 | 81 | 3.8 | 1789 | 483 | 3 |
| | 1,5- | | | | | | |
| | pentanediol | | | | | | |
| 17 | 2,2- | 1.66 | 56 | 5.8 | 2013 | 12500 | 73 |
| | dimethyl- | | | | | | |
| | 1,3- | | | | | | |
| | propanediol | | | | | | |
| 18 | Neopenthyl | 3.0 | 71 | 3.9 | 1047 | 1968 | 190 |
| | glycol | | | | | | |
| | mono(hydro- | | | | | | |
| | xypivalate) | | | | | | |
| 19 | Cyclohexane- | 3.0 | 74 | 0.4 | 931 | 690 | 21 |
| | dimethanol/ | | | | | | |
| | Hexanediol = | | | | | | |
| | 9/1 (molar | | | | | | |
| | ratio) | | | | | | |
| 20 | Cyclohexane- | 2.5 | 66 | 3.6 | 1294 | 2183 | 2 |
| | dimethanol/ | | | | | | |
| | Nonanediol = | | | | | | |
| | 9/1 (molar | | | | | | |
| | ratio) | | | | | | |

### Example 21. Free Radical Stabilization with BHT

A round bottom 1 L flask is equipped with a stirring bar, condenser, distillation adapters, thermocouples, a vacuum pump and vacuum line with a cold trap. The flask is heated using oil bath and reaction temperature is 150° C. The flask is charged with DEMM (300 g), 1,4-butanediol (82 g), sulfuric acid (0.15 g), and pyrophosphoric acid (0.03 g). BHT is used at 2000 ppm level. The pressure is gradually reduced to 350 Torr. The reaction mixture is sampled and the polymer level is measured by 1H NMR using the methylene signal for formed polymer C—C bonds between 2.3-2.7 ppm.

### Example 22. Free Radical Stabilization with BHT and BHA

A roundbottom 300 g flask is equipped with a stirring bar, condenser, distillation adapters, thermocouples, a vacuum pump and vacuum line with a cold trap. The flask is heated using oil bath and the reaction temperature is 150 C. The flask is charged with DEMM (300 g), 1,4-Butanediol (82 g), sulfuric acid (0.15 g), and pyrophosphoric acid (0.03 g). Both BHT and BHA are used at the 1000 ppm level. The pressure is gradually reduced to 350 Torr. The reaction mixture is sampled and the polymer level is measured by 1H NMR using the methylene signal for formed polymer C—C bonds between 2.3-2.7 ppm.

TABLE 7
Effect of BHA/BHT on Free Radical Stabilization

| | | | Polymer level |
|---|---|---|---|
| Example | BHT, ppm | BHA, ppm | by 1H NMR* |
| 21 | 2000 | 0 | 6.36 |
| 22 | 1000 | 1000 | 2.63 |

*Calculated from 1H NMR for the methylene signal for C—C linkages between 2.3-2.7 ppm.

The level of methylene between 2.3-2.7 ppm indicates the level of polymer due to C—C bond formation, which is a result of free radical polymerization. The level of such polymer is higher for BHT used alone at 2000 ppm level vs. BHT used together with BHA at 1000 ppm each. This indicates a synergistic inhibition effect between BHA and BHT, which leads to lower level of formation of undesired polymer.

### Example 23. DEMM Removal and Accelerated Shelf Life Performance

The reaction mixture of example 8 with toluene is used in this Example. (Table 4) After the transesterification, the toluene is removed by a first distillation on the reactor at 70° C. and 10 Torr. The setup used is a 2″ glass Pope WFE setup with cold finger and peristaltic pump feed pump. The conditions used are: WFE Temperature setting: 110° C., Pressure: 0.5 Torr or lower, Feed Rate: 400 ml/h. After the removal of DEMM on WFE the obtained polyester is analyzed and tested for accelerated shelf life performance. The results are shown in Table 8.

TABLE 8
Accelerated Shelf Life and Ambient Test Performance of the Polyester.

| | | Vis- | | | | | | |
|---|---|---|---|---|---|---|---|---|
| | Alkene | cosity, | HMW, | HMW, | Mw, | MSA, | DEMM, | Reactivity, |
| | Number | cP | Da | GPC % | Da | ppm | % | s |
| Day 0 | 74.5 | 334.1 | 119115 | 3.6 | 1783 | 30.2 | 0.09 | 4 |
| 7 days @ 50 C. | 77.1 | 354.2 | 154176 | 2.6 | 1743 | 31.5 | 0.09 | 4 |
| 21 days @ | 75.2 | 367.0 | 183089 | 3.5 | 1842 | 24.4 | 0.14 | 5 |
| 50 C. | | | | | | | | |
| 28 days @ | 71.7 | 358.7 | 156312 | 6.5 | 1922 | 31.6 | 0.47 | 5 |
| 50 C. | | | | | | | | |
| 7 days RT* | 77.6 | 337.6 | 216984 | 4.3 | 1695 | 29.8 | 0.07 | 4 |
| 28 days RT | 71.7 | 358.7 | 125842 | 4.1 | 1755 | 35.2 | 0.06 | 5 |

*RT is ambient storage, at ca. 23° C.

The DEMM content goes down to 0.09 wt % after toluene removal on the reactor at 70 C and 10 Torr followed by DEMM removal by one pass on WFE. The accelerated shelf life study is carried out both at ambient temperature and 50° C. The key properties such as viscosity, molecular weight, acid content, residual DEMM content, and reactivity with 0.5 wt % sodium benzoate remained practically unchanged after 4 weeks at room temperature. After 28 days at 50° C. there is a small increase in residual DEMM, likely due to retro-Michael addition.

Cure Performance and Properties:

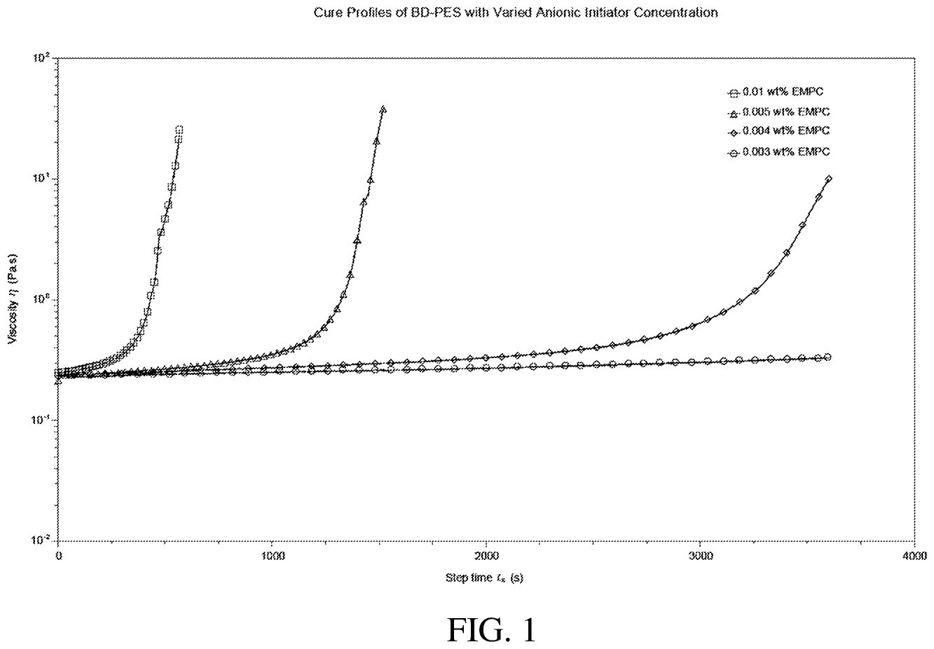

The principal advantages of the polyester prepared using the strong acid stabilizer combination described above is the improved shelf life which is demonstrated by minimal viscosity increase after accelerated aging and small changes in alkene number. The improved stabilization allows for tailoring of potlife and reactivity of the polyester by titrating very low amounts of base initiator. FIG. 1 shows the potlife obtained for the polyester made by this catalysis for 3 different concentrations of ethyl methyl piperidine carboxylate (EMPC), as measured by the time it takes for viscosity to reach 1000 cP when measured on a parallel plate rheometer assembly. This performance will allow formulation of various amine initiated 2K adhesive/coating systems with tunable work time and reactivity balance.

Mechanical properties of the polyester macromer are tested by casting 500 μm thick films using 0.05 wt % EMPC initiator and curing at room temperature. Films are loaded on DMA and subjected to a temperature scan cycle between −50° C. to 160° C. at 5° C./minute and 0.1% strain. Samples are also made using a polyester methylene malonate synthesized using catalytic amount of sulfuric acid with and without pyrophosphoric acid as per the previously disclosed synthetic route (Example 5 and Example 1) followed by DEMM removal by WFE. The comparison between the two samples is highlighted in Table 4. The enhancement in mechanical properties, as measured by the increased glass transition temperature (Tg), storage modulus, and crosslink density for the Example 5 compared to Example 1 can be attributed to lower formation of polymeric impurities. The latter is due to the improved stabilization during the synthesis and reduced residual DEMM level.

TABLE 9
Thermomechanical Properties of Example 1 vs Example 5.

| | Example 1 | Example 5 |
|---|---|---|
| Alkene Number | 69.3 | 67.7 |
| Tg, C. | 43 | 72 |
| G′ (MPa) at −30 C. | 2500 | 2970 |
| G′ (MPa) at 25 C. | 440 | 1200 |
| G′ (MPa) at 140 C. | 66 | 153 |
| Crosslink density (mmol/cm³)* | 6.4 | 14.8 |

*Crosslink density is determined according to the following equation: q = G′rubbery/(3RT);

where q is the crosslink density [mmol/cm3], G'rubbery [MPa] is the storage modulus of the rubbery plateau as measured by dynamic mechanical analysis, R is the universal gas constant, and T [K] is the temperature at which G'rubbery was recorded.

### Examples 24 and 25. Clearcoat Application on Initiating Substrates

Example 24 is a 1,4-butanediol and DEMM based polyester, prepared using the solvent entrainer process, pyrophosphoric acid stabilizer and methanesulfonic acid catalyst. Example 25 is a 1,4-butanediol and DEMM based polyester, is prepared using a vacuum process, pyrophosphoric acid stabilizer, sulfuric acid catalyst. The formulations are prepared and sprayed as 1 K systems on responsive basecoated substrates.

Formulation Compositions

| Components | 24 | 25 |
|---|---|---|
| Polyester, wt % | 59.2 | 59.2 |
| BYK 333, wt % | 0.3 | 0.3 |
| Tinuvin 249, wt % | 0.5 | 0.5 |
| PM Acetate, wt % | 40 | 40 |

Substrate Preparation and Clearcoat Application: BASF Glasurit-90 WA-8555 Black basecoat is spray applied onto E-coated panels at a dry film thickness of 7-10 micron. The basecoats are dried at ambient temperature for 13 min in the fume hood. Formulations containing the polyesters of Examples 24 and 25 are spray applied onto basecoats and cured in the oven at 80° C. for 20 min. Tack-free time and performance of clearcoats are shown in the table below.

Performance of Spray Applied Clear Coats

| | | | | | Cross- | Clear- |
|---|---|---|---|---|---|---|
| | Tack-free | | MEK, | Pencil | hatch | coat |
| | Time at | 60°/20° | Double | Hard- | Ad- | Thick |
| Example | 80° C. | Gloss | Rubs | ness | hesion | ness |
| 24 | 6 min | 86/76.2 | >200 | 8 H | 5 B | 58-61 um |
| 25 | 6 min | 85/74 | >200 | 6 H | 5 B | 62-74 um |

Any numerical values recited include all values from the lower value to the upper value in increments of one unit provided that there is a separation of at least 2 units between any lower value and any higher value. For values which are less than one, one unit is considered to be 0.0001, 0.001, 0.01 or 0.1 as appropriate. These are only examples of what is specifically intended and all possible combinations of numerical values between the lowest value, and the highest value enumerated are to be considered to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. A composition comprising:
a. polyesters containing a chain of residue of:
diols and diesters along the chain, wherein at least a portion of the diesters are 1, 1-diester-1 alkenes, and the chains have alkene groups incorporated into the chains;
b. the composition comprising one or more of the following:
i. ethers derived from alcohols, diols, polyols, or a combination thereof obtained via Michael addition to the alkene groups and a residue of the alkene groups remaining after Michael addition;
ii. the formed polyesters contain one percent or less of residual 1, 1-diester-1-alkene which are unreacted;
iii. one or more free radical inhibitors; and
iv. a stabilizer comprising one or more of: oxo acids of phosphorous or esters thereof, aluminum sulfate, stannous pyrophosphate, stannous sulfate, aluminum dihydrogenphosphate or decomposition products thereof.

2. The composition of claim 1, wherein the one or more 1, 1-diester-1-alkenes are one or more 1,1-di-C₁₋₆ dialkylester-1-alkenes or C₅₋₆ cycloalkyl diester-1-alkenes.

3.-4. (canceled)

5. The composition according to claim 1 wherein, the composition contains one or more strong acids.

6.-11. (canceled)

12. The composition according to claim 1, wherein the percent of the alkene groups present after Michael addition is about 55 or more.

13. The composition according to claim 1, wherein the amount of unreacted 1, 1-diester-1-alkene present in the polyester is about 0.1 percent or less based on the weight of the composition

14. A method comprising:
a. contacting one or more polyols with one or more 1,1-diester 1-alkenes in the presence of a stabilizer comprising one or more of oxo acids of phosphorous or esters thereof, aluminum sulfate, stannous pyrophosphate, stannous sulfate, aluminum dihydrogenphosphate, phosphate esters or decomposition products thereof: and
b. exposing the contacted compounds to conditions under which a composition comprising one or more polyesters according to claim 1.

15. (canceled)

16. The method of claim 14, wherein the one or more polyols and one or more 1, 1-diester 1-alkenes are contacted with a strong acid.

17. (canceled)

18. The method according to claim 14, wherein the strong acid is almost completely converted into esters.

19. The method according to claim 14, comprising removing the unreacted 1,1-diester 1-alkenes remaining after step a.

20. (canceled)

21. The method according to claim 14, comprising removing a portion of the unreacted 1,1-diester 1-alkenes by distillation.

22. The method according to claim 14, comprising adding one or more free radical polymerization inhibitors to the polyester formed while the composition is passed through the wiped film evaporator.

23. The method according to claim 14, including applying vacuum to the polyester formed while passing it through the wiped film evaporator.

24. The method according to claim 14, comprising adding one or more free radical inhibitors to the reaction product.

25. The method according to claim 14, comprising removing, after step a, volatile by-products, unreacted 1,1-diester 1-alkenes, or both by elevating the temperature of the product.

26. The method according to claim 14, comprising applying a vacuum while the temperature of the product is elevated.

27.-32. (canceled)

33. The method according to claim 14, wherein the final composition has a percent of the alkene groups present after Michael addition of about 55 or more.

34.-37. (canceled)

37. The method according to claim 14, comprising adding an entrainer solvent before distillation, continuously during distillation, or both.

38. The method according to claim 14, comprising applying a vacuum to a reaction product before the reaction product is distilled.

39. A composition comprising:
one or more diols;
one or more diesters wherein such diesters comprise one or more 1, 1-diester-1-alkenes; and
one or more stabilizers comprising one or more of oxo acids of phosphorous or esters thereof, aluminum sulfate, stannous pyrophosphate, stannous sulfate, aluminum dihydrogenphosphate, phosphate esters or decomposition products thereof,
wherein the composition forms one or more polyesters containing a chain of residue of the diols and diesters, and the chains have alkene groups incorporated into the chains.

40. (canceled)

41. The composition of claim 39, wherein the 1, 1-diester-1-alkenes comprise one or more 1,1-di-C₁₋₆ dialkylester-1-alkenes and 1,1-di-C₅₋₆ cycloalkylester-1-alkenes.

42.-50. (canceled)
